(19) United States
(12) Patent Application Publication
(10) Pub. No.: US 2006/0116288 A1
(43) Pub. Date: Jun. 1, 2006

(54) Thermal recording material and method of manufacturing the same

(75) Inventors: Mikinaga Mori, Shizuoka-ken (JP); Toshihide Aoshima, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/289,569

(22) Filed: Nov. 30, 2005

(30) Foreign Application Priority Data
Nov. 30, 2004 (JP) 2004-346667

(51) Int. Cl. B41M 5/20

(52) U.S. Cl. 503/216

(57) ABSTRACT

A thermal recording material is provided in which a thermal recording layer containing a color developer represented by the following formula (1) is provided on a substantially transparent polymer support, and a haze value is set to be 65% or less [In formula (1), R¹ to R⁴ each independently hydrogen, an alkyl group, an alkenyl group, an aralkyl group, or a phenyl group; the total number of carbon atoms of R¹ to R⁴ is 2 to 9; M is n-valent metal ion; and n is integer from 1 to 3.].

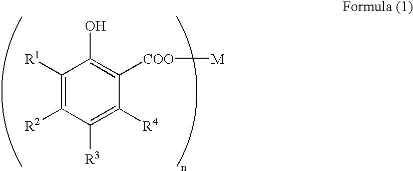

### CROSS-REFERENCE TO RELATED APPLICATION

This application claims priority under 35USC 119 from Japanese Patent Application No. 2004-346667, the disclosure of which is incorporated by reference herein.

### BACKGROUND OF THE INVENTION

1. Field of the Invention

The present invention relates to a thermal recording material and a method of manufacturing the same, more particularly a thermal recording material which is better in thermal sensitivity and storage stability of an image, and is particularly suitable for recording a medical image, and a method of manufacturing the same.

2. Description of the Related Art

Since a thermal recording material has advantages that (1) development is not necessary, (2) when a support is a paper, quality of a material is near a plain paper, (3) handling is easy, (4) a density of developed color is high, (5) a recording device is simple, high reliability and inexpensive, (6) a noise at recording is small, (7) maintenance is not necessary, and the like, the material has been utilized in a variety of fields in recent years. A thermal recording material has extended utility, for example, in the field of a medical image in addition to the field of a facsimile and a printer, and the field of a label such as POS and the like.

In the field of a medical image, as fundamental performance required in a thermal recording material, there are high translucency (transparency) at a non-colored portion, color developing sensitivity, and storage stability of an image (particularly, concentration stability under high temperature environment). Among them, regarding translucency (transparency) at a non-colored part, it was said that it is difficult to obtain high translucency mainly due to voids in a film, in a solid dispersion thermal recording material. However, by using a color developer in the form of an emulsion dispersion as described in Japanese Patent Application Laid-Open (JP-A) No. 1-108086, a layer in which components are densely filled can be constructed, and this greatly contributes to translucency (transparency).

However, in a medical image, particularly, extremely high translucency (transparency) is required at a non-developed part, and it is important performance that a thermal recording material is of transparency. Therefore, it is not necessarily sufficient to adopt an emulsion dispersion as described above. In addition, previously, regarding technique of obtaining a thermal recording material having high transparency utilizing micro-capsules, JP-A No. 63-45084 and JP-A No. 11-70742 propose many examples. However, problems that transparency is decreased due to crystal precipitation and aggregation of an emulsion dispersion of a color developer, and a concentration of an intermediate concentration part is easily increased under a high temperature have not been completely overcome, and it is unavoidable to further improve design of a color developer for use in the medical field. Therefore, only the previous techniques which have hitherto been proposed have not satisfied both of sufficient translucency performance and image storage performance as required in the field of a medical image.

In order to suppress a change in an image concentration in response to variation in environment and recording condition (temperature and humidity, a resistance value scatter, an offset position, a pushing pressure scatter of a thermal head etc.), weakening of sensitivity property is contemplated. However, in weakening property, high heat energy is necessary in order to obtain the greatest concentration, and burden on an outermost layer of a thermal recording material in contact with a thermal head becomes large, leading to a defect such as surface roughening. In order to reduce this heat energy, higher sensitivity is strongly sought.

In a system in which an electron donating dye precursor is present in a polymer resin by encapsulating in micro-capsules utilizing a polyurethane or urea resin, or formulating into composite particles, higher sensitivity greatly relies on permeability of a color developer for a resin. That is, higher sensitivity can be achieved by increasing permeability of a color developer for a resin at a printing image temperature.

Permeability of a color developer for a resin can be increased to obtain higher sensitivity by reducing a molecular size of a color developer. However, generally, there is a tendency that permeability at storage is also increased and, consequently, image storage property is deteriorated. Conversely, there is a tendency that, when one tries to maintain high image storage property required as a medical image, high sensitivity is not obtained. Therefore, development of new technique has been demanded for increasing permeability of a color developer for a resin at image recording where a temperature is relatively elevated, and suppressing the permeability at storage where a temperature is relatively lowered.

Under restriction that high transparency is maintained as described above, it was usually difficult to realize both of higher sensitivity and image storage property in designing a molecule or formulation of a color developer. In development of a color developer, there is an example using a metal salt of salicylic acid in JP-A No. 2004-142143. However, this merely found out the effect that an image having a high color developing concentration is obtained, but this is problematic in order to construct a recording material suitable in medical utility, which maintains transparency, and can attain both of higher sensitivity and image storage property.

### SUMMARY OF THE INVENTION

As described above, under the current circumstances, technique of securing higher sensitivity and image storing property simultaneously while high translucency (transparency) requiring, particularly, as a medical image is maintained, has not been established yet.

The present invention was done in view of the above circumstances, and an object of the invention is to provide a thermal recording material which is highly sensitive, excellent in stability of storing a recorded image, better in translucency (transparency), and particularly suitable in medical utility, and a method of manufacturing the same.

The finding was obtained that a metal salt of salicylic acid having a relatively small molecular weight is easily diffused in micro-capsules or a polymer (composite particles) at heating, is effective in higher sensitivity, is excellent in image storing property, and is effective in imparting transparency due to low crystallizability as compared with zinc 3,5-α-methylbenzylsalicylate which has previously been used, and the invention was done based on such the finding. Specific means for attaining the aforementioned object is as follows:

A first aspect of the invention is to provide a thermal recording material comprising a thermal recording layer on a substantially transparent polymer support, the thermal recording layer containing composite particles containing a colorless or light colored electron donating dye precursor in a polymer or micro-capsules encapsulating a colorless or light colored electron donating dye precursor, and a color developer,
wherein the color developer is a compound represented by the following formula (1), and the haze value of the thermal recording material is 65% or less: 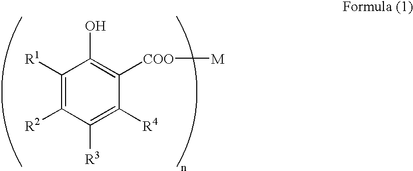
   wherein R¹, R², R³, and R⁴ each independently represent a hydrogen atom, an alkyl group, an alkenyl group, an aralkyl group or a phenyl group; the total number of carbon atoms of R¹, R², R³, and R⁴ is in the range of from 2 to 9; R¹, R², R³, and R⁴ may be bonded to each other to form a ring when at least two selected from the group consisting of R¹, R², R³, and R⁴ bind to a neighboring carbon atom; M represents an n-valent metal ion; and n represents an integer from 1 to 3.

A second aspect of the invention is to provide a method of manufacturing a thermal recording material, which comprises coating on a support a coating solution using a solid dispersion in which at least one kind of a compound represented by the following formula (1) which causes a colorless or light colored electron donating dye precursor to form color is solid-dispersed, to form a thermal recording layer: 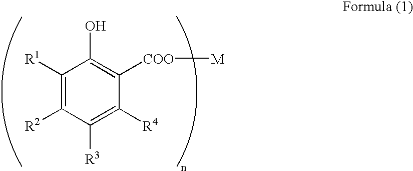
wherein R¹, R², R³, and R⁴ each independently represent a hydrogen atom, an alkyl group, an alkenyl group, an aralkyl group or a phenyl group; the total number of carbon atoms of R¹, R², R³, and R⁴ is in the range of 2 to 9; R¹, R², R³, and R⁴ may be bonded to each other to form a ring when at least two selected from the group consisting of R¹, R², R³, and R⁴ bind to a neighboring carbon atom; M represents an n-valent metal ion; and n represents an integer from 1 to 3.

### DETAILED DESCRIPTION OF THE INVENTION

The thermal recording material of the present invention is constructed such that a compound represented by the following formula (1) is selected as a color developer, and the material has transparency as the haze value being 65% or less. The thermal recording material of the invention will be explained in detail below, and a method of manufacturing the thermal recording material of the invention will be also described in detail through the explanation.

The thermal recording material of the invention has at least one thermal recording layer on a substantially transparent polymer support and, if necessary, other layer such as an intermediate layer and a protective layer can be provided.

Thermal Recording Layer

The thermal recording layer in the invention comprises at least composite particles containing an electron donating dye precursor in a polymer, or micro-capsules encapsulating an electron donating dye precursor, and a compound represented by the following formula (1) (color developer) and, if necessary, the thermal recording layer comprises other component such as a binder.

-Compound Represented by the Formula (1)-

The thermal recording layer in the invention contains at least one of a compound represented by the following formula (1) (hereinafter, also referred to as “color developer in the invention”) as a color developer which makes an electron donating dye precursor described later by reacting with it at heating. By selecting this compound as a color developer, both of sensitivity and image storing property can be improved and, at the same time, the selection is particularly effective in imparting translucency (transparency).

That is, the color developer in the invention is a metal salt of salicylic acid having a relatively small molecular weight and, as compared with a metal salt of salicylic acid which has been generally used previously (zinc 3,5-α-methylbenzylsalicylate etc.), the color developer in the invention is easily diffused in micro-capsules or a polymer (composite particles) at recording by heat application, and is particularly effective in enhancing sensitivity. In addition, besides this, although mechanism of action is not necessarily clear, an unshared electron pair of a urethane or urea group in a resin constituting micro-capsules or composite particles strongly interferes with a vacant orbital of a metal ion and, as a result, activation energy for transmission and diffusion is high, that is, dependency on a temperature in a process of transmission into a resin is great. For this reason, it is considered that image storing property can be improved in spite of high sensitivity. In addition, since crystallizability is low and, further, it is easy to finely divide the color developer in solid dispersing, opacification due to voids which have previously been generated easily by coating upon formulation into a solid dispersion can be effectively suppressed, and this is particularly effective in enhancing transparency.

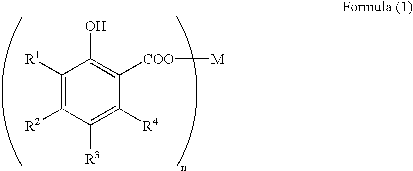

In the above formula (1), R¹, R², R³, and R⁴ each independently represent a hydrogen atom, an alkyl group, an alkenyl group, an aralkyl group or a phenyl group, and the total number of carbon atoms of R¹, R², R³, and R⁴ is from 2 to 9.

In the invention, it is important that a sum of the carbon number of R¹ to R⁴ in the formula (1) (total carbon number) is in the range of from 2 to 9, that is, the color developer is of a low molecular weight. In particular, by adopting the above range, image storing property can be improved in spite of high sensitivity.

The alkyl group represented by R¹ to R⁴ may be unsubstituted or substituted, and an alkyl group of a carbon number of 1 to 9 is preferable. Examples include a methyl group, an ethyl group, a normal propyl group, an isopropyl group, a normal butyl group, an isobutyl group, a tertiary butyl group, a normal hexyl group, a normal octyl group, a normal nonyl group, an isononyl group, a tertiary nonyl group, and a cyclohexyl group. Inter alia, an alkyl group of a carbon number of 1 to 8 is more preferable, and a methyl group, an ethyl group, a normal propyl group, an isopropyl group, a normal butyl group, an isobutyl group, and a tertiary butyl group are particularly preferable.

The alkenyl group represented by R¹ to R⁴ may be unsubstituted or substituted, and an alkenyl group of a carbon number of 2 to 9 is preferable. Examples include a vinyl group, an allyl group, a 1-propenyl group, a 2-butenyl group, a 1,3-butadienyl group, a 2-pentenyl group, a 1,3-pentadienyl group, a 1-hexenyl group, a 3-octenyl group, and a 1-nonenyl group. Inter alia, an alkenyl group of a carbon number of 2 to 8 is more preferable, and a vinyl group, an allyl group, a 1-propenyl group, a 2-butenyl group, and a 1,3-butadienyl group are particularly preferable.

The aralkyl group represented by R¹ to R⁴ may be unsubstituted or substituted, and an aralkyl group of a carbon number of 7 to 9 is preferable. Examples include a benzyl group, a α-methylbenzyl group, a phenethyl group, and a cinnamyl group. Inter alia, an aralkyl group of a carbon number of 7 to 8 is more preferable, and a benzyl group, a α-methylbenzyl group, and a phenethyl group are particularly preferable.

Examples of a substituent when the alkyl group, the alkenyl group, and the aralkyl group have a substituent, include an alkoxy group, an aryloxy group, an alkylthio group, an arylthio group, an amino group, an acyl group, an alkoxycarbonyl group, an aryloxycarbonyl group, a carbamoyl group, an acylamino group, an alkoxycarbonylamino group, an aryloxycarbonylamino group, a carbamoylamino group, an alkylsulfonylamino group, an arylsulfonylamino group, and a halogen atom.

In addition, the phenyl group represented by R¹ to R⁴ may be unsubstituted, or may be a substituted phenyl group (carbon number 7 to 9) having a substituent of a carbon number of 1 to 3. Preferable examples include a phenyl group, a tolyl group, a xylyl group, a mesityl group, and a cumyl group. A phenyl group is particularly preferable.

Among them, as R¹ to R⁴, a hydrogen atom, a methyl group, an ethyl group, a normal propyl group, an isopropyl group, a vinyl group, an allyl group, a benzyl group, a α-methylbenzyl group, and a phenyl group are preferable.

Alternatively, when at least two of R¹, R², R³, and R⁴ are bonded to a neighboring carbon atom constituting a benzene ring, respectively, these may be bonded to each other to form a ring. As a ring to be formed, a benzene ring and a cyclohexyl ring are preferable.

In the above formula (1), M represents an n-valent (n=1to 3) metal ion, and preferable examples include an aluminum ion (Al³⁺), an iron ion (Fe³⁺), (Fe²⁺), a nickel ion (Ni²⁺), a copper ion (Cu²⁺), and a zinc ion (Zn²⁺). Inter alia, from a viewpoint of color developing sensitivity and whiteness at a non-developed part, a divalent zinc ion is preferable.

Among compounds represented by the formula (1), compounds represented by the following formulas (2) to (5) are preferable in that the effect of the invention can be exerted more effectively.

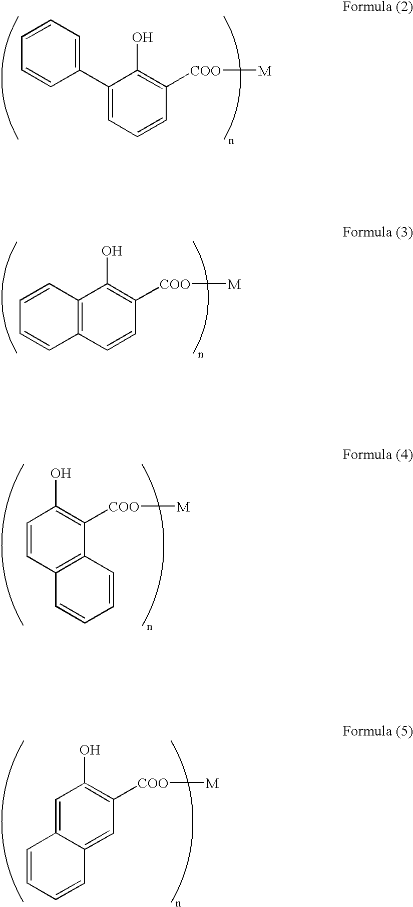

In the formulas (2) to (5), M represents an n-valent metal ion, and n represents an integer from 1 to 3. M has the same meaning as that in the formula (1), a preferable aspect thereof is the same and, particularly, a divalent zinc ion is preferable.

Embodiments of compounds represented by the formulas (1) to (5) (color developer in the invention) will be shown below. However, the invention is not limited to them.

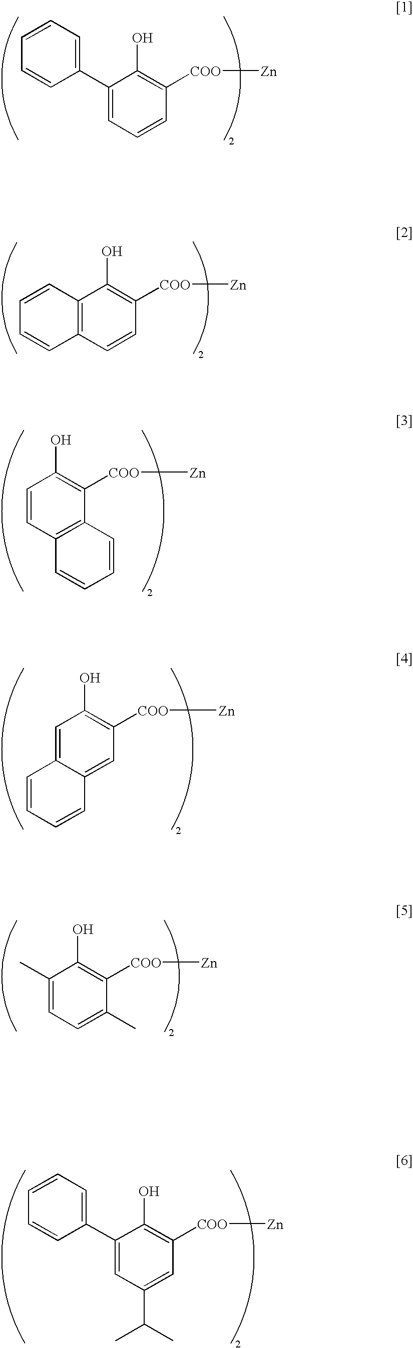

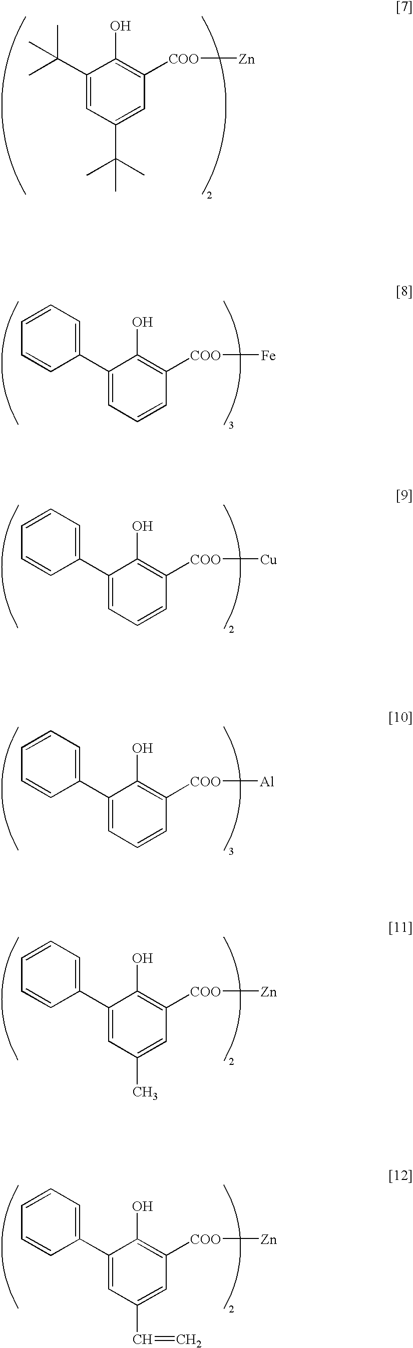

The color developer in the invention may be used in either aspect of an emulsion dispersion using a cosolvent (ethyl acetate; same below), or a solid dispersion using no cosolvent. From a viewpoint of imparting translucency (transparency), an emulsion dispersion is generally effective. However, since the color developer in the invention has property that it is easily finely-divided particularly by solid dispersing even when suitability in emulsion dispersing is deficient such as deteriorated stability of dissolution in a cosolvent, it is also preferable that the color developer is contained in an aspect of solid dispersing. From this point of view, particularly, zinc 3-phenylsalicylate, zinc 1-hydroxy-2-naphthoate, zinc 2-hydroxy-1-naphthoate, and zinc 2-hydroxy-3-naphthoate are preferable.

When compounds represented by the formulas (1) to (5) (color developer in the invention) are used in an aspect of solid dispersing, it is preferable that an average particle diameter is 0.5 μm or less as expressed by a 50% volume average particle diameter from a viewpoint that the haze value is small, and high translucency (transparency) is obtained. This 50% volume average particle diameter is an average particle diameter of color developer particles corresponding to a 50% volume in the color developer in the invention, which is measured by a laser diffraction method, and is measured by a laser diffraction particle size distribution measuring apparatus (trade name: LA-700, manufactured by Horiba, Ltd.). In the above range, 0.3 μm or less is more preferable.

Alternatively, it is also possible to use the known other color developers (electron receiving compound) together with the color developer represented by the formula (1).

Examples of other color developers include acidic substances such as a phenol compound, an organic acid or a metal salt thereof, and oxybenzoic acid ester, for example, compounds described in JP-A No. 61-291183. Specifically, examples include bisphenols such as 2,2-bis(4′-hydroxyphenyl)propane [bisphenol A], 2,2-bis(4′-hydroxyphenyl)pentane, 2,2-bis(4′-hydroxy-3′,5′-dichlorophenyl)propane, 1,1-bis(4′-hydroxyphenyl)cyclohexane, 2,2-bis(4′-hydroxyphenyl)hexane, 1,1-bis(4′-hydroxyphenyl)propane, 1,1-bis(4′-hydroxyphenyl)butane, 1,1-bis(4′-hydroxyphenyl)pentane, 1,1-bis(4′-hydroxyphenyl)hexane, 1,1-bis(4′-hydroxyphenyl)heptane, 1,1-bis(4′-hydroxyphenyl)octane, 1,1-bis(4′-hydroxyphenyl)-2-methyl-pentane, 1,1-bis(4′-hydroxyphenyl)-2-ethyl-hexane, 1,1-bis(4′-hydroxyphenyl)dodecane, 1,4-bis(p-hydroxyphenylcumyl)benzene, 1,3-bis(p-hydroxyphenylcumyl)benzene, bis(p-hydroxyphenyl)sulfone, bis(3-allyl-4-hydroxyphenyl)sulfone, and bis(p-hydroxyphenyl)acetic acid benzyl ester; salycilic acid derivatives such as 3,5-di-α-methylbenzylsalicylic acid, 3-α-α-dimethylbenzylsalicylic acid, and 4-(4-(β-p-methoxyphenoxyethoxy)salicylic acid; or a polyvalent metal salt thereof (particularly, zinc and aluminum are preferable); oxybenzoic acid esters such as p-hydroxybenzoic acid benzyl ester, p-hydroxybenzoic acid-2-ethylhexyl ester, β-resorcylic acid-(2-phenoxyethyl) ester; phenols such as p-phenylphenol, 3,5-diphenylphenol, cumylphenol, 4′-hydroxy-4′-isopropoxy-diphenylsulfone, and 4-hydroxy-4′-phenoxy-diphenylsulfone. Inter alia, bisphenols are particularly preferable in color developing properties.

A content of the color developer in the invention (and other color developer) in a thermal recording layer is preferably 0.5 to 30.0 parts by mass, more preferably 1.0 to 10.0 parts by mass relative to 1 part by mass of an electron donating dye precursor described later. When the content is particularly in the above range, better color developing property (density of developed color) is obtained and, at the same time, better image storing property is obtained while sensitivity is enhanced, and it is possible to impart high translucency (transparency).

Alternatively, when other color developer is used together with the color developer in the invention, a ratio of the color developer in the invention occupied in a total amount of color developers is preferably 5% by mass or more, preferably 10% by mass or more, more preferably 20% by mass or more. In addition to the case where only the color developer in the invention is used, in the case where other color developer is used jointly, when a ratio of the color developer in the invention is in the above range, a density of a developed color is better, additionally, better image storing property is obtained in spite of higher sensitivity and, moreover, it is possible to impart high translucency (transparency) to a thermal recording layer.

-Electron Donating Dye Precursor-

The thermal recording layer in the invention contains at least one kind of electron donating dye precursor which develops a color by reacting with the color developer at heating. The electron donating dye precursor is contained in the thermal recording layer in an aspect of being contained in a polymer (composite particles), or in an aspect of being encapsulated in micro-capsules.

An electron donating dye precursor preferable in the invention is not particularly limited as far as it is colorless or light colored. The precursor has nature that it donates an electron, or receives a proton such as an acid, thereby, it develops a color. As the electron donating dye precursor, particularly, a colorless or light colored compound which has a partial skeleton such as lactam, sultone, spiropyran, ester and amide, and in which when contacted with the aforementioned color developer, these partial skeletons are ring-opened or cleaved, is preferable.

Examples of the electron donating dye precursor include a triphenylmethanephthalide-based compound, a fluoran-based compound, a phenothiazine-based compound, an indolylphthalide-based compound, a leukoauramine-based compound, a rhodaminelactam-based compound, a triphenylmethane-based compound, a triazene-based compound, a spiropyran-based compound, a fluorene-based compound, a pyridine-based compound, and a piperazine-based compound.

Example of the triphenylmethanephthalide-based compound include compounds described in U.S. reissued Pat. No. 23024, and U.S. Pat. Nos. 3,491,111, 3,491,112, 3,491,116, and 3,509,174. Examples of the fluoran-based compound include compounds described in U.S. Pat. Nos. 3,624,107, 3,627,787, 3,641,011, 3,462,828, 3,681,390, 3,920,510, and 3,959,571. Examples of the spiropyran-based compound include compounds described in U.S. Pat. No. 3,971,808.

Examples of the pyridine-based and piperazine-based compounds include compounds described in U.S. Pat. Nos. 3,775,424, 3,853,869, and 4,246,318. Examples of the fluorene-based compound include compounds described in JP-A No. 63-94878.

Among them, particularly preferable examples include 2-arylamino-3-[H,halogen,alkyl or alkoxy-6-substituted aminofluoran] which develops black.

Specifically, examples include 2-anilino-3-methyl-6-diethylaminofluoran,
2-anilino-3-methyl-6-N-cyclohexyl-N-methylaminofluoran,
2-p-chloroanilino-3-methyl-6-dibutylaminofluoran, 2-anilino-3-methyl-6-dioctylaminofluoran,
2-anilino-3-chloro-6-diethylaminofluoran,
2-anilino-3-methyl-6-N-ethyl-N-isoamylaminofluoran,
2-anilino-3-methyl-6-N-ethyl-N-dodecylaminofluoran,
2-anilino-3-methoxy-6-dibutylaminofluoran, 2-o-chloroanilino-6-dibutylaminofluoran,
2-p-chloroanilino-3-ethyl-6-N-ethyl-N-isoamylaminofluoran,
2-o-chloroanilino-6-p-butylanilinofluoran, 2-anilino-3-pentadecyl-6-diethylaminofluoran,
2-anilino-3-ethyl-6-dibutylaminofluoran, 2-o-toluidino-3-methyl-6-diisopropylaminofluoran,
2-anilino-3-methyl-6-N-isobutyl -N-ethylaminofluoran,
2-anilino-3-methyl-6-N-ethyl-N-tetrahydrofurfurylaminofluoran,
2-anilino-3-chloro-6-N-ethyl-N-isoamylaminofluoran,
2-anilino-3-methyl-6-N-methyl-N-γ-ethoxypropylaminofluoran,
2-anilino-3-methyl-6-N-ethyl-N-γ-ethoxypropylaminofluoran,
2-anilino-3-methyl-6-N-ethyl-N-γ-propoxypropylaminofluoran,
3-6-bis(hexyloxy)-2-(2-thienyl)-spiro[4H-3,1-benzoxazine-4,9′-[9H]xanthrene], and
3-6-bis(hexyloxy)-2-(2-phenyl)-spiro[4H-3,1-benzoxazine-4,9′-[9H]xanthrene].

A content of the electron donating dye precursor in the thermal recording layer is preferably 0.1 to 5.0 g/m², more preferably 1.0 to 4.0 g/m². When the content is in the above range, a sufficient density of a developed color is obtained. In addition, when contents of both of the electron donating dye precursor and the color developer are within 5.0 g/m², a sufficient density of a developed color can be retained and, at the same time, transparency of the thermal recording layer can be retained high.

Then, a use aspect of the electron donating dye precursor and the color developer will be described.

In the invention, the electron donating dye precursor is contained in the thermal recording layer by encapsulating in micro-capsules (microcapsulation) or being contained in a polymer (composite particles). A method of manufacturing micro-capsules and a method of being contained in composite particles (polymer) will be described in detail below.

-Method of Manufacturing Micro-Capsules-

For manufacturing micro-capsules, there are an interface polymerization method, an internal polymerization method, and an external polymerization method, and any method can be adopted.

As described above, in one preferable aspect of the thermal recording material of the invention, the electron donating dye precursor is encapsulated in micro-capsules. Particularly, it is preferable to adopt an interface polymerization method, that is, a method of placing an oily phase prepared by dissolving or dispersing an electron donating dye precursor which is to be a core of a capsule in a hydrophobic organic solvent, in an aqueous phase in which a water-soluble polymer is dissolved, emulsification-dispersing this with a stirring means such as a homogenizer, thereafter, and warming the dispersion to cause a polymer forming reaction at an oily phase/aqueous phase interface, to form a micro-capsule wall consisting of a polymer material.

A reactant which forms the polymer material is added to an interior of an oil droplet and/or an exterior of an oil droplet. Examples of the polymer material include polyurethane, polyurea, polyamide, polyester, polycarbonate, urea-formaldehyde resin, melamine resin, polystyrene, styrene methacrylate copolymer, and styrene-acrylate copolymer. Among them, polyurethane, polyurea, polyamide, polyester, and polycarbonate are preferable, and polyurethane and polyurea are particularly preferable.

For example, when polyurea is used as a capsule wall material, a micro-capsule wall can be easily formed by reacting polyisocyanate such as diisocyanate, triisocyanate, tetraisocyanate, and polyisocyanate prepolymer, polyamine such as diamine, triamine, tetramine, tetraethylenepentamine, and diethylenetriamine (most preferably, tetraethylenepentamine, and diethylenetriamine), a prepolymer having two or more amino groups, piperazine or a derivative thereof or a polyol in an aqueous phase by an interface polymerization method.

In addition, for example, a composite wall consisting of polyurea and polyamide, or a composite wall consisting of polyurethane and polyamide can be made, for example, by mixing polyisocyanate and a second substance which reacts therewith to form a capsule wall (e.g. acid chloride, polyamine, or polyol) into a water-soluble polymer aqueous solution (aqueous phase) or an oily medium to be capsulated (oily phase), emulsification-dispersing them, and warming the dispersion. Details of a method of manufacturing this composite wall consisting of polyurea and polyamide are described in JP-A No. 58-66948.

As the polyisocyanate, a compound having a tri- or more-isocyanate group is preferable, but bifunctional isocyanate may be used together. Specifically, examples include polyfunctionalized polyisocyanates obtained by making an adduct of diisocyanate such as hexamethylene diisocyanate, tolylene diisocyanate and a hydrogenate thereof, and isophorone diisocyanate as a main raw material, and a dimer or trimer thereof (biuret or isocyanurate) and, additionally, polyol such as trimethylolpropane, and bifunctional isocyanate such as xylylene diisocyanate, compounds in which a high-molecular compound such as polyether having active hydrogen such as polyethylene oxide is introduced in an adduct of polyol such as trimethylolpropane and bifunctional isocyanate such as xylylene diisocyanate, and formalin-condensate of benzene isocyanate. Compounds described in JP-A No. 62-212190, JP-A No. 4-26189, JP-A No. 5-317694, and JP-A No. 10-114153 are preferable.

The polyisocyanate is preferably added so that an average particle diameter of micro-capsules is 0.3 to 12 μm, and a thickness of a capsule wall is 0.01 to 0.3 ∥m. A diameter of dispersed particles is generally approximately 0.2 to 10 μm.

Examples of polyol or/and polyamine which is added to an aqueous phase and/or oily phase as one of components which are reacted with polyisocyanate to constitute a micro-capsule wall include propylene glycol, glycerin, trimethylolpropane, triethanolamine, sorbitol, and hexamethylenediamine. When polyol is added, a polyurethane wall is formed. From a viewpoint of increasing a reaction rate, it is preferable to maintain a reaction temperature high, or add a suitable polymerization catalyst in the aforementioned reaction.

The aforementioned polyisocyanate, polyol, reaction catalyst, and polyamine for forming a part of a wall material are described in detail, for example, in “Polyurethane Handbook” edited by Keiji Iwata (Nikkankogyoshinbunsha, 1987).

In addition, if necessary, a charge regulating agent such as a metal-containing dye, and nigrosine, or other arbitrary additive may be added to the micro-capsule wall. These additives can be contained in a wall of a capsule at formation of a wall or at an arbitrary time. In addition, if necessary, in order to regulate electrifying property of a capsule wall surface, a monomer such as a vinyl monomer may be graft-polymerized.

Further, a micro-capsule wall can be also made to be of wall quality that substance permeability is excellent, and color developing property is rich even under the situation of a lower temperature and, in this case, it is preferable to use a plasticizer suitable for a polymer used as a wall material jointly. A plasticizer has a melting point of preferably 50° C. or higher, more preferably 120° C. or lower. Among the plasticizer, a plasticizer which is solid under a normal temperature can be suitably selected for use. For example, when a wall material consists of polyurea or polyurethane, a hydroxy compound, a carbamic acid ester compound, an aromatic alkoxy compound, an organic sulfonamide compound, an aliphatic amide compound, and an arylamide compound are preferably used.

As a hydrophobic organic solvent which dissolves an electron donating dye precursor upon preparation of an oily phase and is used for forming a core of a micro-capsule, a low boiling point organic solvent having a boiling point of 50 to 150° C. which has high solubility, and does not remain in a capsule after a capsulation reaction is preferable in view of image storing property. Examples of such the low boiling point organic solvent include ester organic solvents such as ethyl acetate, isopropyl acetate, and butyl acetate, and methylene chloride. Ethyl acetate is most preferable.

When solubility of an electron donating dye precursor which is to be a solute is inferior, or polarity of an electro donating dye precursor is high, and cannot be separated from a microcapsule whale better, a hydrophobic oil having a relatively high boiling point can be used jointly. Since the hydrophobic oil remains in a capsule also after a capsulating reaction, this results in deterioration of image storing property in some cases. However, since phosphoric acid esters such as tricresyl phosphate, benzoic acid esters such as isopentyl benzoate, maleic acid esters such as dibutyl maleate, and boric acid esters such as polybutyl borate can be used suitably and, in particular, tricresyl phosphate has relatively better emulsion stability and image storing property, they are preferable.

On the other hand, as an aqueous phase, an aqueous solution in which a water-soluble polymer as a protective colloid is dissolved is used, the aforementioned oily phase is placed into this, and this is emulsion-dispersed by a means such as a homogenizer. The water-soluble polymer acts as a dispersing medium which makes dispersing uniform and easy and, at the same time, stabilize an emulsion-dispersed aqueous solution. Examples of a preferable protective collide include polyvinyl alcohol (PVA) and, in particular, modified PVA having a hydrophobicized end can suppress aggregation and settlement at emulsification or at a capsulation reaction. Thereupon, in order to further uniformly emulsion-disperse and stabilize this, a surfactant may be added to at least one of a oily phase and an aqueous phase. As the surfactant, the well-known surfactant for emulsification can be used, and an addition amount when the surfactant is used is preferably 0.1 to 5% by mass, more preferably 0.5 to 2% by mass relative to an oily phase (mass).

As a surfactant to be contained in an aqueous phase, among anionic or nonionic surfactants, a surfactant which does not act on the protective colloid to cause precipitation or aggregation can be suitably selected and used. Preferable examples of the surfactant include sodium alkylbenzene sulfonate, sodium alkylsulfate, sodium dioctyl sulfosuccinate, polyalkylene glycol (e.g. polyoxyethylene nonyl phenyl ether), and acetylene glycol derivative.

An oily phase containing the aforementioned various components and an aqueous phase containing the protective colloid and the surfactant can be easily emulsified using a normal stirring means which is used for emulsifying fine particles such as high speed stirring and ultrasound dispersing, for example, the known emulsifying apparatus such as a homogenizer, manton-Goulin, an ultrasound dispersing machine, a dissolver, and Kdmill. After the emulsification, in order to promote a capsule wall forming reaction, it is preferable to warm an emulsion to 30 to 70° C. In addition, during a reaction, in order to prevent aggregation of capsules, it is preferable to add water to lower a probability of collision of capsules, or perform sufficient stirring.

Alternatively, a dispersion for preventing aggregation may be added again during a reaction. Accompanying with progress of a polymerization reaction, evolution of a carbonic acid gas is observed, and completion of the evolution can be regarded as an endpoint of a capsule wall forming reaction. Usually, by a reaction for a few hours, desired micro-capsules can be obtained.

-Method of being Contained in Composite Particles (Polymer)-

In the thermal recording material of the invention, as described above, a form where an electron donating dye precursor is contained as composite particles by being contained in a polymer is also one of preferable aspects. As a method of making an electron donating dye precursor contained in a polymer, a polyvalent isocyanate compound which is a polymerization compound in used as a solvent without using an organic solvent, and an electron donating dye precursor is dissolved therein. Alternatively, by the same method as the aforementioned method of manufacturing microcapsules, composite particles which is to be a polymer containing an electro donating dye precursor can be manufactured (formation into composite particles).

Regarding composite particles, details described, for example, in JP-A No. 9-263057 can be referred. Since in this aspect of composite particles, solubility of a solute is restricted, an amount of composite particles to be coated is increased than necessary one, it is difficult to perfectly perform segregation between an electron donating dye precursor and an electron receiving compound (color developer), and texture coloration and deterioration of image storing property are easily accompanied, an aspect of encapsulation in micro-capsules is more preferable in the invention.

-Emulsion/Solid Dispersion-

Then, details of a form of using a color developer to be contained with composite particles containing a colorless of light color electron donating dye precursor in a polymer, or micro-capsules encapsulating a colorless or light colored electron donating dye precursor, that is, a color developer dispersion (emulsion dispersion, solid dispersion) will be explained in detail.

When microcapsulation is performed using an electron donating dye precursor as a core substance, or when formulating into composite particles is performed by being contained in a polymer, a color developer (the aforementioned color developer in the invention and other color developer; electron receiving compound) can be preferably used as an emulsion dispersion obtained by dissolving it in a water-hardly soluble or insoluble organic solvent in advance, mixing this solution (oily phase) with a polymer aqueous solution (aqueous phase) containing a surfactant and/or a water-soluble polymer as a protective colloid, and emulsion-dispersing the mixture using a homogenizer. In this case, if necessary, a low boiling point solvent may be used as a dissolution assistant.

In addition to emulsion dispersing, in the color developer in the invention, an aspect using the developer as a solid dispersion is also preferable because property that fine dividing upon solid dispersing can be easily performed is possessed. Specifically, a color developer (the aforementioned color developer in the invention and other color developer; electron receiving compound) is not dissolved in a water-hardly soluble or insoluble organic solvent or a dissolution assistant, but is directly added to an aqueous polymer solution containing a surfactant and/or a water-soluble polymer as a protective colloid, this is solid-dispersed with a Dinomill to finely-divide it to obtain a solid dispersion, which can be preferably used.

A water-soluble polymer used upon emulsion dispersing and solid dispersing can be appropriately selected from the known anionic polymers, nonionic polymers, and amphoteric polymers, and a water-soluble polymer having solubility of 5% or more in water at a temperature at which emulsification is intended is preferable. Specific examples include ethylene-vinyl acetate copolymer, styrene-maleic anhydride copolymer, ethylene-maleic anhydride copolymer, isobutylene-maleic anhydride copolymer, polyvinylpyrrolidone, ethylene-acrylic acid copolymer, vinyl acetate-acrylic acid copolymer, cellulose derivatives such as carboxymethylcellulose and methylcellulose, casein, gelatin, starch derivative, gum arabic, and sodium alginate. Among them, polyvinyl alcohol and modified polyvinyl alcohol, gelatin and modified gelatin, and cellulose derivatives are particularly preferable.

In addition, in emulsion dispersing, a mixing ratio of an oily phase relative to an aqueous phase (oily phase mass/aqueous phase mass) is preferably 0.02 to 0.6, more preferably 0.1 to 0.4. When the mixing ratio is in the range of 0.02 to 0.6, an appropriately viscosity can be retained, manufacturing suitability is excellent, and coating solution stability is excellent.

In the aforementioned color developing component, depending on the purpose, other components such as the known heat melting substance, ultraviolet absorption agent and antioxidant can be appropriately selected and can be contained in the thermal recording layer in the invention.

The heat melting substance can be contained in the thermal recording layer for the purpose of improving thermal responsiveness. Examples of the heat melting substance include aromatic ether, thioether, ester, aliphatic amide, and ureide. Examples of them are described in JP-A Nos. 58-57989, 58-87094, 61-58789, 62-109681, 62-132674, 63-151478, 63-235961, 2-184489, and 2-215585.

Preferable examples of the ultraviolet absorption agent include a benzophenone-based ultraviolet absorption agent, a benzotriazole-based ultraviolet absorption agent, a salicylic acid-based ultraviolet absorption agent, a cyanoacrylate-based ultraviolet absorption agent, and an oxalic acid aniline-based ultraviolet absorption agent. Examples of them are described in JP-A Nos. 47-10537, 58-111942, 58-212844, 59-19945, 59-46646, 59-109055, and 63-53544, Japanese Patent Application Publication (JP-B) Nos. 36-10466, 42-26187, 48-30492, 48-31255, 48-41572, 48-54965, and 50-10726, U.S. Pat. Nos. 2,719,086, 3,707,375, 3,754,919 and 4,220,711.

Preferable examples of the antioxidant include a hindered amine-based antioxidant, a hindered phenol-based antioxidant, an aniline-based antioxidant, and a quinoline-based antioxidant. Examples of them are described in JP-A Nos. 59-155090, 60-107383, 60-107384, 61-137770, 61-139481, and 61-160287.

An amount of these other components is preferably approximately 0.05 to 1.0 g/m², more preferably 0.1 to 0.4 g/m². Other components may be added to the aforementioned micro-capsules or polymer, or may be added to an exterior of the microcapsules or polymer.

The thermal recording layer in the invention can be formed, for example, by preparing a coating solution for forming a thermal recording layer (thermal recording layer coating solution) containing the aforementioned microcapsules and the compound represented by the formula (1) (and, if necessary, other color developer), and coating the thermal recording layer coating solution on a polymer support directly or via other layer such as an undercoating layer.

The thermal recording layer coating solution can be prepared by mixing a solution of micro-capsules encapsulating an electron donating dye precursor or composite particles containing an electron donating dye precursor prepared by the aforementioned method with at least one color developer dispersion in which the compound represented by the formula (1) (and, if necessary, other color developer) is solid-dispersed or emulsion-dispersed. Thereupon, by using, as a color developer dispersion, a solid dispersion in which the compound represented by the formula (1) (and, if necessary, other color developer) is solid-dispersed, or using a color developer dispersion obtained by mixing this solid dispersion with an emulsion dispersion in which the other color developer is emulsion-dispersed with or without the compound represented by the formula (1), the thermal recording layer coating solution can be suitably prepared.

When a water-soluble polymer is used as a protective colloid upon preparation of a micro-capsule solution in the above case, as well as when a water-soluble polymer is used as a protective colloid upon preparation of the aforementioned color developer dispersion, these water-soluble polymers function as a binder in a thermal recording layer. Alternatively, besides these protective colloids, a thermal recording layer coating solution may be prepared by adding and mixing a binder.

As a binder to be added, a water-soluble binder is general, and examples include polyvinyl alcohol, hydroxyethylcellulose, hydroxypropylcellulose, epichlorohydrin-modified polyamide, ethylene-maleic anhydride copolymer, styrene-maleic anhydride copolymer, isobutylene-maleinsalicylic anhydride copolymer, polyacrylic acid, polyacrylic amide, methylol-modified polyacrylamide, starch derivative, casein, and gelatin.

In addition, for the purpose of imparting water resistance to these binders, a water resistant agent may be added, or an emulsion of a hydrophobic polymer, specifically, styrene-butadiene rubber (SBR) latex, or acryl resin emulsion may be added.

When the thermal recording layer coating solution is coated on a polymer support, the known coating means used in an aqueous or organic solvent-based coating solution can be applied. In order to safely and uniformly coat the thermal recording layer coating solution and, at the same time, retain a coated film strength, in the thermal recording material of the invention, methylcellulose, carboxymethylcellulose, hydroxyethylcellulose, starches, gelatin, polyvinyl alcohol, carboxy-modified polyvinyl alcohol, polyacrylamide, polystyrene or a copolymer thereof, polyester or a copolymer thereof, polyethylene or a copolymer thereof, epoxy resin, acrylate-based resin or a copolymer thereof, methacrylate-based resin or a copolymer thereof, polyurethane resin, polyamide resin, and polyvinyl butyral resin can be used.

It is preferable that the thermal recording layer in the invention is a thermal recording layer having a wide energy amount width necessary for obtaining a saturated transmission concentration (Dₜ₋ₘₐₓ), that is, a wide dynamic range in order to form an image of high image quality by suppressing a concentration scatter caused by a slight difference in heat conductivity of a thermal head. It is preferable that the thermal recording material of the invention has the aforementioned thermal recording layer, and has property that a transmission concentration (Dₜ₋ₘₐₓ)=3.0 can be obtained at a thermal energy amount in the range of 70 to 130 mJ/mm².

The thermal recording layer in the invention can be coated so that a solid matter coating amount after coating and drying is 1 to 25 g/m². A layer thickness may be in the range of 1 to 25 μm. A form of a layer thickness of 15 μm or less is particularly preferable from a viewpoint that it is preferable in medical utility. In addition, two or more thermal recording layers may be laminated. In this case, an aspect that a solid matter coating amount of a total thermal recording layer which has been coated and dried is 1 to 25 g/m² is preferable.

Other Layer

In the thermal recording material of the invention, in addition to the aforementioned thermal recording layer, a back coating layer, a protective layer, an intermediate layer, an undercoating layer, or ultraviolet-ray filter layer as other layer can be further provided on a substantially transparent polymer support.

-Back Coating Layer-

In the thermal recording material of the invention, a form is preferable in which a back coating layer is provided on a side where a thermal recording layer of a polymer support is not provided. The back coating layer can be preferably constructed by using a matting agent and a water-soluble polymer.

The matting agent is added for the purpose of imparting conveyance property and preventing light reflection. By adding the matting agent, the gloss value measured at an incident light angle of 20° is preferably 50% or less, more preferably 30% or less.

Examples of the matting agent include fine particles of a synthetic polymer such as a cellulose fiber, a polystyrene resin, an epoxy resin, a polyurethane resin, a urea formalin resin, a poly(meth)acrylate resin, a polymethyl (meth)acrylate resin, a copolymer resin of vinyl chloride or vinyl acetate, and polyolefin, and inorganic fine particles of calcium carbonate, titanium oxide, kaolin, smectite clay, aluminum hydroxide, silica, and zinc oxide in addition to fine particles of starch obtained from barley, wheat, corn, rice, and beans. An average particle diameter of the matting agent is preferably 0.5 to 20 μm, more preferably 0.5 to 10 μm. The matting materials may be used alone or two of more of them may be used together.

As the water-soluble polymer, gelatin, polyvinyl alcohol, polyvinylpyrrolidone and cellulose derivatives can be used, and gelatin is particularly preferable.

A refractive index is preferably in the range of 1.4 to 1.8 in that transparency of a thermal recording material is made to be better. In the back coating layer, various dyes (e.g. C.I. Pigment Blue 60, C.I. Pigment Blue 64, C.I. Pigment Blue 15:6) can be used from a viewpoint of improvement in a hue. In addition, a hardener may be used and, as an example of the hardener, a vinylsulfone-based compound described in T. H. James “THE THEORY OF THE PHOTOGRAPHIC PROCESS 4^{th} EDITION” (PP. 77-87) is preferable.

-Protective Layer-

The protective layer is formed on a thermal recording layer or, when an intermediate layer as other layer is provided on a thermal recording layer, is formed on the intermediate layer. This protective layer is usually formed by coating a protective layer coating solution, and the protective layer coating solution preferably contains a pigment and a lubricant in order to impart better head matting property over a wide recording energy region. The lubricant containing (A) a lubricant which is liquid at a normal temperature of a has a melting point of lower than 40° C., and (B) a lubricant having a melting point of 40° C. or higher is preferable.

As the “lubricant which is liquid at a normal temperature”, there are silicone oil, liquid paraffin, and lanolin, and silicone oil is particularly preferable. The silicone oil may have a substituent such as a carboxyl group and a polyoxyethylene group and, as a viscosity of the silicone oil, 100 to 100000 cps is preferable.

Examples of the “lubricant having a melting point of lower than 40° C.” include polyoxyethylene alkyl ether, polyoxyethylene alkyl ether acetate, and polyoxyethylene alkyl ether sulfate, and polyoxyethylene alkyl ether phosphate. Inter alia, polyoxyethylene alkyl ether phosphate represented by the following formula is particularly preferable.
[R—O—(CH₂CH₂O)ₙ]ₓ—P(═O)—(OH)_{y}

In the formula, x+y=3, R represents an alkyl group, and the alkyl group may be substituted with a substituent. And, n represents an integer from 2 to 50.

The aforementioned “lubricant which is liquid at a normal temperature” and “lubricant having a melting point of 40° C. of lower” may be used alone, or two more kinds, may be used jointly.

As the “lubricant having a melting point of 40° C. or higher”, a lubricant having a melting point of 160° C. or lower, preferably a melting point of 140° C. or lower is desirable, and examples include stearic acid amide (melting point 100° C.), methylolstearic acid amide (101° C.), polyethylene wax (melting point 100° C. or lower), paraffin wax having a melting point of 50 to 90° C., glycerin tri-12-hydroxystearate (melting point 88° C.), oleic acid amide (melting point 73° C.), zinc oleate (melting point 75° C.), lauric acid amide (melting point 84° C.), aluminum stearate (melting point 102° C.), manganese stearate (melting point 112° C.), zinc stearate (melting point 125° C.), calcium stearate (melting point 160° C.), ethylene bisstearoamide (melting point 140° C.), magnesium stearate (melting point 132° C.), magnesium palmitate (melting point 122° C.), and magnesium myristate (melting point 131° C.). This “lubricant having a melting point of 40° C. or higher” may be used alone, or two or more kinds of them may be used jointly.

When the lubricant is insoluble in water, it is preferably added to a protective layer in a form of a dispersion or an emulsion. In addition, when the lubricant is a solid, (1) it can be used in a form of a dispersion in water in which the lubricant is dispersed with the known dispersing machine such as a homogenizer, a dissolver and a sand mill in the presence of a water-soluble polymer such as polyvinyl alcohol and a dispersing agent such as various surfactants, or (2) after dissolution in a solvent, the lubricant can be used in a form of an emulsion in which the lubricant is emulsion-dispersed with the known emulsification apparatus such as a homogenizer, a dissolver and a colloid mill in the presence of a water-soluble polymer and a dispersing agent such as various surfactants. When the lubricant is a liquid, it can be used in a form of an emulsion. An average particle diameter of a dispersion or an emulsion is preferably 1.0 to 7.0 μm, more preferably 1.0 to 2.0 μm. Herein, an average particle diameter refers to a 50% volume average particle diameter measured at a transmittance of 71±1% using, for example, a laser diffraction particle size distribution measuring apparatus (trade name: LA-700, manufactured by Horiba, Ltd.).

On the other hand, a lubricant which is soluble in water such as polyoxyethylene alkyl ether, polyoxyethylene alkyl ether acetate, polyoxyethylene alkyl ether sulfate, and polyoxyethylene alkyl ether phosphate can be added to a protective layer by dissolving it at an arbitral concentration in view of solubility.

In addition, in order to prevent peeling of a coated film at cutting and damage upon handling, a protective layer of the thermal recording material of the invention has preferably a surface scratching hardness prescribed in JIS K6718 of 40 g or more. In the invention, as a test method for the surface scratching hardness, using a continuous weight loading scratching strength testing machine, a protective layer surface is scratched with a cone-type scratching needle (tip R:0.1 mm) made of sapphire by continuously changing weight loading in the range of 0 to 200 g during a movement distance of 100 mm, this is color-developed to a transmission concentration of 1.2, this is observed under transmitted light, and a scratching hardness is obtained from a movement distance during which a concentration change has occurred due to a flaw.

It is preferable that a protective layer contains a pigment. As the pigment, usually, an organic and/or inorganic pigment used for the purpose of making recording with a thermal head preferable, that is, suppressing occurrence of sticking or an abnormal sound is used. It is preferable that the pigment has its average particle diameter, specifically, a 50% volume average particle diameter measured by a laser diffraction method [an average particle diameter of pigment particle corresponding to a 50% volume in a pigment, measured by a laser diffraction particle size distribution measuring apparatus (trade name: LA-700, manufactured by Horiba, Ltd.); hereinafter, also simply referred to as “average particle diameter”] of 0.10 to 5.0 μm. In particular, from a viewpoint that occurrence of sticking or an abnormal sound between a thermal head and a thermal recording material is prevented upon recording with a thermal head, the 50% volume average particle diameter is preferably in the range of 0.20 to 0.50 μm. When this 50% volume average particle diameter is in the range of 0.10 to 5.0 μm, so-called sticking phenomenon in which the effect of reducing friction against a thermal head is increased and, as a result, a thermal head and a protective layer for a thermal recording material are adhered at recording can be effectively prevented.

A pigment usable in a protective layer is not particularly limited, but examples include the known organic and inorganic pigments. Particularly, inorganic pigments such as calcium carbonate, titanium oxide, kaolin, aluminum hydroxide, amorphous silica, and zinc oxide, and organic pigments, such as a urea formalin resin, and an epoxy resin are preferable. Among them, kaolin, aluminum hydroxide, and amorphous silica are more preferable. These pigments may be used alone, or two or more kinds of them may be used jointly. In addition, among the aforementioned pigments, a pigment having a surface covered with at least one or two or more kinds selected from the group consisting of higher fatty acid, a metal salt of higher fatty acid, and higher alcohol can be suitably used. Examples of the higher fatty acid include stearic acid, palmitic acid, myristic acid, and lauric acid.

These pigments are preferably used after they are dispersed to the aforementioned average particle diameter with the known dispersing machine such as a dissolver, a sand mill, and a ball mill in the presence of a dispersing assistant such as sodium hexametaphosphate, partially saponified or completely saponified polyvinyl alcohol, polyacrylic acid copolymer, and various surfactants, preferably partially saponified or completely saponified, polyvinyl alcohol, or polyacrylic acid copolymer ammonium salt. That is, it is preferable that the pigments are used after they are dispersed until a 50% volume average particle diameter of the pigments becomes a particle diameter in the range of 0.1 to 5.0 μm.

It is also preferable that a binder such as polyvinyl alcohol, carboxy-modified polyvinyl alcohol, and silica-modified polyvinyl alcohol is used in the protective layer from a viewpoint of improvement in transparency. In addition, the known hardener may be contained in the protective layer, and examples thereof include inorganic compounds such as boric acid, borax, and colloidal silica, and the following dialdehyde derivative (1).

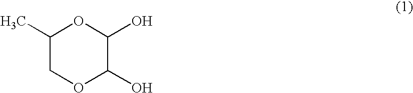

It is preferable to add a surfactant to a coating solution for forming a protective layer in order to uniformly provide a protective layer on a thermal recording layer or an intermediate layer by coating. In addition, metal oxide fine particles, an inorganic electrolyte, or a polymer electrolyte may be added to a protective layer for the purpose of preventing electrification of a thermal recording material. As the surfactant, a sulfosuccinic acid-based alkali metal salt, and a fluorine-containing surfactant are preferable, and specific examples include a sodium salt, a potassium salt and an ammonium salt of di-(2-ethylhexyl)sulfosuccinic acid and di-(n-hexyl)sulfosuccinic acid, acetylene glycol derivative, a sodium salt, a potassium salt, and an ammonium salt of perfluoroalkylsulfate, and perfluoroalkylbetaine compound.

A dry coating amount for a protective layer is preferably 0.2 to 7 g/m², more preferably 1 to 4 g/m². A protective layer may have either of a monolayer structure, or a lamination structure of two or more layers.

-Intermediate Layer-

An intermediate layer can be constructed using a binder, and is preferably formed on a thermal recording layer. An intermediate layer is provided for the purpose of preventing mixing of layers, or blocking a gas (oxygen etc.) which is harmful to image storing property. The binder is not particularly limited, and polyvinyl alcohol, gelatin, polyvinylpyrrolidone, and cellulose derivative can be appropriately selected depending on a system. Inter alia, since gelatin is excellent in nature (setting property) that an aqueous solution of it has flowability at a high temperature, but at a low temperature (e.g. 35° C. or lower), it loses flowability, and is gelled, when a layer is provided on a support by coating and drying a coating solution for forming a plurality of layers, in any of a method of successively coating and drying a plurality of layers, and a method of coating a plurality of layers at once by an extrusion dye format, adjacent layers can be effectively prevented from mixing with each other, the plane state of the resulting thermal recording material becomes better, and a thermal recording material which can form an image of high quality can be obtained. For this reason, this is suitable for constructing a recording material for medical diagnosis which is required to form a clear high quality image to fine parts. Further, even when dried at a high wind speed, since the plane state is not deteriorated, a manufacturing efficacy can be improved.

As gelatin, any of non-modified (untreated) gelatin and modified (treated) gelatin can be used without a problem. Examples of the modified gelatin include lime-treated gelatin, acid-treated gelatin, phthlation-treated gelatin, deionization-treated gelatin, and enzyme-treated low molecular weight gelatin. In addition, for imparting coating property, various surfactants may be added. In addition, for enhancing gas barrier property, inorganic fine particles such as mica may be added at 2 to 20% by mass, more preferably 5 to 10% by mass relative to the binder.

It is suitable that a binder concentration of a coating solution for forming an intermediate layer is 3 to 25% by mass, preferably 5 to 15% by mass. In addition, it is suitable that a dry coating amount of an intermediate layer is 0.5 to 6 g/m², preferably 1 to 4 g/m².

-Undercoating Layer-

In the thermal recording material of the invention, an undercoating layer can be provided on a polymer support before coating of a thermal recording layer or a back coating layer for the purpose of preventing peeling of a thermal recording layer from a polymer support. The undercoating layer can be constructed using acrylic acid ester copolymer, polyvinylidene chloride, SBR or aqueous polyester, and a layer thickness is preferably 0.05 to 0.5 μm.

Since when a thermal recording layer is coated on an undercoating layer, an undercoating layer is swollen by water contained in a coating solution for forming a thermal recording layer, and an image recorded on a thermal recording layer is deteriorated in some cases, it is preferable to perform curing using a hardener such as dialdehydes such as glutaraldehyde, and 2,3-dihydroxy-1,4-dioxane, and boric acid in an undercoating layer. The hardener can be appropriately added in conformity with a desired curing degree in the range of 0.2 to 3.0% by mass depending on a mass of an undercoating material.

-Light Shielding Layer-

In addition to the aforementioned layers, a light shielding layer may be further provided for the purpose of preventing light fading of an image and texture fog. The light shielding layer is such that an ultraviolet absorption agent is uniformly dispersed in a binder. Due to absorption of ultraviolet-ray light with a uniformly dispersed ultraviolet absorption agent, texture discoloration, and discoloration or fading at an image portion can be prevented. Regarding a method of manufacturing a light shielding layer and compounds to be used, the description of JP-A No. 4-197778, as well as a ultraviolet absorption agent such as a benzotriazole series, a benzophenone series, and a hindered amine series can be utilized.

Support

The thermal recording material of the invention is constructed by using, as a support, a substantial transparent polymer support (hereinafter, also referred to as “transparent support”). Since the support has substantial transparency, high translucency can be imparted to a non-colored portion in utility where light is transmitted upon viewing an image such as a medical image, particularly, in the medical field.

Substantially transparent refers to the state where light is transmitted, and a passage direction can be visually confirmed, and the state where clouding is small, the support is transparent, and transmission of light is hardly lost is desirable.

Examples of the transparent support include synthetic polymer films such as polyester films of polyethylene terephthalate (PET) and polybutylene terephthalate, cellulose triacetate film, and polyolefin films of polypropylene and polyethylene, and these can be used alone, or by applying a plurality of them.

Particularly, in the case of medical utility, the transparent support may be colored with a blue dye (e.g. dye-1 described in Example of JP-A No. 8-240877), or may be not colored. It is preferable that the transparent support is undercoated with gelatin or water-soluble polyester. Regarding an undercoating layer, undercoating layers described, for exampled, in JP-A Nos. 51-11420, 51-123139, and 52-65422 can be utilized.

A thickness of the transparent support in the invention is desirably φμm or more, more preferably 150 to 200 μm and, in particular, an aspect where the support is constructed of polyethylene terephthalate of 100 μm or more is preferable.

In addition, the synthetic polymer film constituting the transparent support may be colored with an obitrary hue. Examples of a method of coloring the synthetic polymer film include a method of kneading a dye in a resin before molding a resin film, and molding a film, and a method of preparing a coating solution in which a dye is dissolved in a suitable solvent, and coating this on a colorless transparent resin film by the known coating method such as a gravure coating method, a roller coating method, and a wire coating method. Inter alia, it is preferable that a polyester resin such as polyethylene terephthalate and polyetheylene naphthalate in which a blue dye has been kneaded therein is formed into a film, and this is subjected to heat resistance treatment, stretching treatment, or antistatic treatment.

In particular, when the thermal recording material of the invention having transparency is observed from a transparent support side on a shircustane in medical use, an illusion is generated with shircustane light transmitting through a non-colored portion which remains transparent, and an image which is seen with difficulty is produced in some cases. In order to avoid this, it is particularly preferable to use, as a transparent support, a synthetic polymer film which is colored blue in a square region formed of four points of A(x=0.2805, y=0.3005), B(x=0.2820, y=0.2970), C(x=0.2885, y=0.3015), and D(x=0.2870, y=0.3040) on a chromaticity coordinate defined by the method described in JIS-Z8701.

Haze Value

The thermal recording material of the invention is such that the haze value is 65% or less. As described in above, high translucency (transparency) is required particularly in the field of a medical image. By adopting the haze value calculated from (diffusion transmittance/total light transmittance)×100(%) in the aforementioned range, an image which is suitable in medical utility, and excellent in transparency at a non-colored portion can be obtained. Generally, when a solid dispersion of a color developer is coated, transparency is deteriorated. However, under construction in which the color developer in the invention is selectively solid-dispersed, transparency is not substantially deteriorated.

This haze value is an index indicating transparency of a material and, generally, is calculated from a total light transmitted amount, a diffusion transmitted light amount, and a parallel transmitted light amount using a hazemeter. In the invention, examples of a method of making the haze value in the aforementioned range include, in addition to contribution of the aforementioned color developer in the invention to transparency, (1) a method of adopting a 50% volume average particle diameter of both color developing components [an electron donating dye precursor and the color developer in the invention (and, if necessary, other color developer)] contained in a thermal recording layer of 1.0 μm or less, preferably 0.6 μm or less, and adopting a binder amount in the range of 30 to 60% by mass of a total solid matter of a thermal recording layer, and (2) a method of encapsulating any one of both of color developing components in micro-capsules, and making the other contained as, for example, an emulsion which constitutes a substantially continuous layer after coating and drying. Alternatively, (3) a method of approaching a refractive index of components contained in a thermal recoding layer at a constant value as near as possible is also effective.

A method of manufacturing the thermal recording material of the invention will be explained below.

The thermal recording material of the invention can be constructed, for example, by coating a thermal recording layer coating solution on a support directly or via other layer such as an undercoating layer to provide a thermal recording layer, further coating a coating solution for forming a protective layer on this thermal recording layer to form a protective layer and, a further, if necessary, forming other layer such as an intermediate layer. Herein, a thermal recording layer and a protective layer may be formed simultaneously. In that case, a thermal recording layer and a protective layer provided on the layer can be formed simultaneously by coating doubly a thermal recording layer coating solution and a coating solution for forming a protective layer on a support.

Herein, as a support, the aforementioned support can be used. In addition, as the thermal recording layer coating solution, the aforementioned thermal recording layer coating solution containing micro-capsules and a color developer including a compound represented by the formula (1) can be used and, as a coating solution for forming a protective layer, the aforementioned protective layer coating solution containing a pigment and a binder can be used. Further, as other layer, the aforementioned undercoating layer, intermediate layer, ultraviolet-ray filter layer, and back coating layer can be provided.

The thermal recording layer in the invention may be coated and formed by any method, and examples of the coating method include various coating procedures including extrusion coating, slide coating, curtain coating, knife coating, dipping coating, flow coating, and extrusion coating using a kind of a hopper described in U.S. Pat. No. 2,681,294. Extrusion coating or slide coating described in “LIQUID FILM COATING” (Stephen F. Kistler, Petert M. Schwaizer, published by CHAPMAN & HALL, 1997, p. 399-p. 536) are preferable, and slide coating is particularly preferable. An example of a phase of a slide coater used in slide coating is described in the same document p. 427, FIG. 11.b1. Optionally, two or layers may be formed simultaneously by the method described in the same document p.399-p.536, or the methods described in U.S. Pat. No. 2,761,791 and British Patent No. 837095. Regarding drying condition, drying can be performed with a drying wind at a dry-bulb temperature of 20 to 65° C.(preferably 25 to 55° C.), and a wet-bulb temperature of 10 to 30° C. (preferably 15 to 25° C.).

According to the method of manufacturing the thermal recording material of the invention, the aforementioned thermal recording material of the invention can be manufactured.

When recording is performed using the thermal recording material of the invention, it can be performed using a thermal head and, as this thermal head, a thermal head in which a protective layer is provided on a heating element equipped with a heating resistor and an electrolyte on a glaze layer using the known film making apparatus so that a carbon ratio of an uppermost layer in contact with the thermal recording material becomes 90% or more, is preferable. This protective layer may be constructed of two or more layers, and it is necessary that at least uppermost layer has a carbon ratio of 90% or more.

### EXAMPLES

The present invention will be further specifically explained below by way of Examples, but the invention is not limited to the following Examples as far as it is not beyond the gist thereof. Unless indicated otherwise, “%” is based on a mass.

### Examples 1

<Preparation of Protective Layer Coating Solution>

1) Preparation of Protective Layer Pigment Dispersion

To 900 g of water, was added 280 g of aluminum hydroxide (trade name: HIDILITE H42S, manufactured by SHOWA DENKO K.K.) which had been subjected to surface treatment with stearic acid as a pigment, this was stirred for 3 hours, 8.5 g of a dispersing assistant (trade name: POISE 532A, manufactured by Kao Corporation), 300 g of a 10% aqueous polyvinyl alcohol solution (trade name: PVA105, manufactured by Kuraray Co., Ltd.), and 75 g of a 2% aqueous solution of a compound “CH₃(CH₂)₇CH═CH(CH₂)₇—CON(CH₃)—CH₂CH₂SO₃Na” were added thereto, they were dispersed to an average particle diameter of 0.33 μm with a sand mill, and water was further added thereto to prepare a protective layer pigment dispersion having an adjusted concentration of 18%.

The aforementioned average particle diameter refers to an average particle diameter of pigment particles corresponding to a 50% volume of a total pigment obtained by dispersing a pigment in the presence of a dispersing agent, adding water to the pigment dispersion immediately after dispersing to dilute to 0.5%, placing the resulting test solution into warm water at 40° C., adjusting light transmittance to 72±1%, performing ultrasound treatment over 30 seconds, and measuring the diameter using a laser diffraction particle size distribution measuring apparatus (trade name: LA700, manufactured by Horida, Ltd.). Hereinafter, an average particle diameter indicates an average particle diameter measured by the same method in all cases.
2) Preparation of Protective Layer Lubricant Dispersion

To 280 g of water, was added 110 g of glycerin tri-12-hydroxystearate (trade name: K3 WAX500, manufactured by Kawaken Fine Chemical) as a lubricant, this was stirred for 3 hours, 3 g of a dispersing assistant (trade name: POISE 532A, manufactured by Kao Corporation), 340 g of a 10% aqueous polyvinyl alcohol solution (trade name: MP103, manufactured by Kuraray Co., Ltd.), and 34 g of a 2% aqueous solution of a compound “CH₃(CH₂)₇CH═CH(CH₂)₇—CON(CH₃)—CH₂CH₂SO₃Na” were added thereto, they were dispersed to an average particle diameter of 0.26 μm with a sand mill, and water was further added thereto to 18% to prepare a protective layer lubricant dispersion. Thereupon, a concentration of glycerin tri-12-hydroxystearate used as a lubricant was 13.6%.
3) Preparation of Protective Layer Coating Solution

430 g of a 5% aqueous solution of polyvinyl alcohol (trade name: PVA-124C, manufactured by Kuraray Co., Ltd.), 5 g of 72% aqueous solution of sodium dodecylbenzenesulfate, 5.5 g of a 50% solution of an acetylene glycol-based surfactant (trade name: SURFINOL 104, manufactured by Nishinkagaku), 10 g of “trade name: SURFORON S131S, manufactured by Asahi Glass Company”, 2 g of polyoxyethylene alkyl ether phosphate having a melting point of 35° C. (trade name: PLYSURF A217E, manufactured by Dai-ichi Kogyo Seiyaku Co., Ltd.), 245 g of the above-obtained 18% protective layer pigment dispersion, 10 g of the above-obtained 18% protective layer lubricant dispersion, 1 g of a 20.5% zinc stearate dispersion (trade name: F115, manufactured by Chukyo Oil & Fat Co., Ltd.), 31 g of a 18% stearic acid dispersion (trade name: CELLOSOL 920, manufactured by Chukyo Oil & Co., Ltd.), 41.5 g of a 35% dispersion of a silicone oil in water (trade name: BY22-840, manufactured by Toray Dow Coming), 110 g of a 5% aqueous solution of styrene maleic acid copolymer ammonium salt (trade name:, POLYMALON 385, manufactured by Arakawa Chemical Industries, Ltd.), 53 g of a 20% aqueous solution of colloidal silica (trade name: SNOWTEX, manufactured by Nissan Chemical Industries, Ltd.), 70 g of a 4% aqueous boric acid solution, 30 g of a 2% aqueous acetic acid solution, and 22 g of a 50% aqueous solution of the following dialdehyde derivative (1) (hardener) were mixed. To this mixed solution, was further added water, to prepare a protective layer coating solution having an adjusted concentration of 12%. 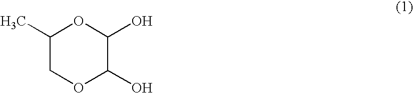
<Preparation of Thermal Recording Layer Coating solution>

According to the following procedures, a micro-capsule solution encapsulating an electron donating dye precursor as a core substance, as well as a solid dispersion of an electron receiving compound (color developer) and an emulsion dispersion were prepared, respectively.
1) Preparation of Electron Donating Dye-Encapsulated Micro-Capsule Solution A

As an electron donating dye precursor, 63.7 g of a compound represented by the following structural formula [201], 21 g of a compound represented by the following structural formula [202], 10.8 g of a compound represented by the following structural formula [203], 5.8 g of a compound represented by the following formula [204], 2.2 g of a compound represented by the following structural formula [205], 2.7 g of a compound represented by the following structural formula [206], and 2.6 g of a compound represented by the following structural formula [207] were added to 110 g of ethyl acetate, this was heated to 70° C. to dissolve the materials, and cooled to 45° C. Thereafter, to this was added 70 g of a capsule wall material (trade name: TAKENATE 140N, manufactured by Takeda Chemical Industries, Ltd.), followed by mixing.

This mixed solution was added to 300 g of an aqueous phase of a 5.9% aqueous solution of polyvinyl alcohol (trade name: MP-103, manufactured by Kuraray Co., Ltd.), and emulsion dispersing was performed using an Ace homogenizer (manufactured by Nippon Seiki Co., Ltd.) at a rotation number of 15000 r.p.m. To the resulting emulsion solution were added 275 g of water and 6.5 g of tetraethylenepentamine, and an encapsulation reaction was performed at a temperature of 60° C. over 4 hours. Finally, water was added to adjust a concentration to 25%, to prepare a solution A of electron donating dye-encapsulated micro-capsules having an average diameter of 0.8 μm.
2) Preparation of Electron Donating Dye-Encapsulated Micro-Capsule Solution B

As an electron donating dye precursor, 54.5 g of a compound represented by the following structural formula [201], 14.8 g of a compound represented by the following structural formula [202], 10.5 g of a compound represented by the following structural formula [203], 6.4 g of a compound represented by the following structural formula [204], 3.4 g of a compound represented by the following structural formula [205], 0.5 g of a compound represented by he following structural formula [206], and 2.1 g of a compound represented by the following structural formula [207] were added to 110 g of ethyl acetate, this was heated to 70° C. to dissolve the materials, and cooled to a temperature of 45° C. Thereafter, to this was added 65.5 g of a capsule wall mateial (trade name: TAKENATE D127N, manufactured by Takeda Chemical Industries, Ltd.), followed by mixing.

This mixed solution was added to 275 g of an aqueous phase of a 5.9% aqueous solution of polyvinyl alcohol (trade name: MP-103, manufactured by Kuraray Co., Ltd.), and emulsion dispersing was performed using an Ace homogenizer (manufactured by Nippon Seiki Co., Ltd.) at a rotation number of 15000 r.p.m. To the resulting emulsion solution were added 275 g of water and 5.70 g of tetraethylenepentamine, and an encapsulation reaction was performed at a temperature of 60° C. over 4 hours. Finally, water was added to adjust a concentration to 28%, to prepare a solution B of electron donating dye-encapsulated micro-capsules having an average diameter of 0.3 μm. 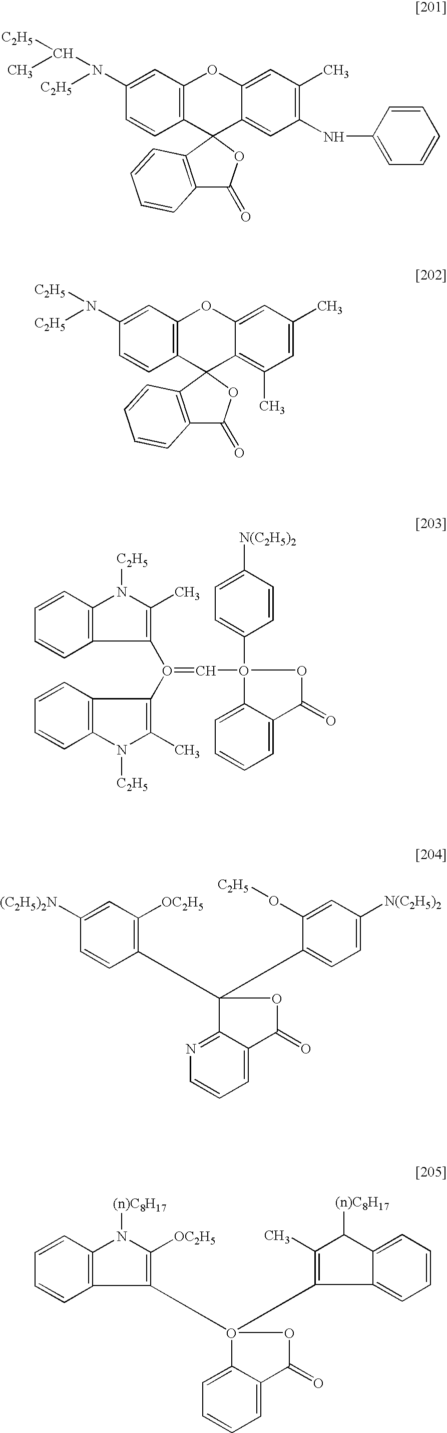 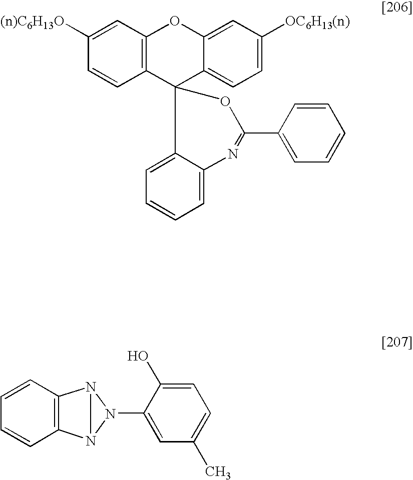
3) Preparation of Color Developer Dispersion

A mixed powder obtained by mixing 14.6 g of a compound represented by the following structural formula [1] (the aforementioned compound represented by the formula (1)) as a color developer, and 1.23 g of a compound represented by the following structural formula [301] as an ultraviolet absorption agent was added to an aqueous phase obtained by mixing 42 g of water, 24.9 g of a 8% aqueous solution of polyvinyl alcohol (trade name: PVA-217C, manufactured by Kuraray Co., Ltd.), 7.2 g of a 15% aqueous solution of polyvinyl alcohol (trade name PVA-205C, manufactured by Kuraray Co., Ltd.), 7.2 g of a 15% aqueous solution of polyvinyl alcohol (trade name: MP203, manufactured by Kuraray Co., Ltd.), and 12.7 g of a 2% aqueous solution of a compound represented by the following structural formula [401], to disperse them, which was finely-divided using a Dinomill (manufactured by Sinmal Enterprise) to a color developer solid dispersion having an average diameter of 0.15 μm.
4) Preparation of Color Developer Emulsion Dispersion

22.0 g of a compound represented by the following structural formula [302], 8.0 g of a compound represented by the following structural formula [303], 2.6 g of a compound represented by the following structural formula [304], 2.6 g of a compound represented by the following structural formula [305], and 0.5 g of a compound represented by the following structural formula [306] as a color developer, and 4.0 g of a compound represented by the following structural formula [301] as an ultraviolet absorption agent together with 1.0 g of tricresyl phosphate and 0.5 g of diethyl maleate were added to 16.5 g of ethyl acetate, and this was heated to 70° C. to dissolve the materials.

This mixed solution was added to an aqueous phase obtained by mixing 67 g of water, 55 g of a 8% aqueous solution of polyvinyl alcohol (trade name: PVA-217C, manufactured by Kuraray Co., Ltd.), 19 g of a 15% aqueous solution of polyvinyl alcohol (trade name: PVA-205C, manufactured by Kuraray Co., Ltd.), 11 g of a 2% aqueous solution of a compound represented by the following structural formula [402], and 11 g of a 2% aqueous solution of a compound represented by the following structural formula [403], and this was emulsion-dispersed to an average particle diameter of 0.7 μm at a rotation number of 10000 r.p.m. using an Ace homogenizer (manufactured by Nippon Seiki Co., Ltd.), to prepare a color developer emulsion dispersion. 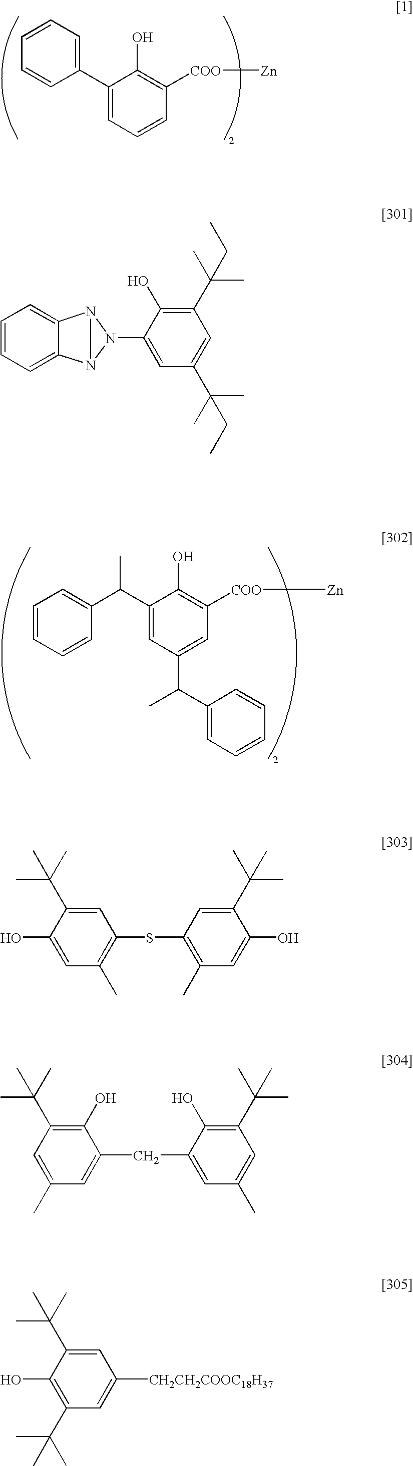 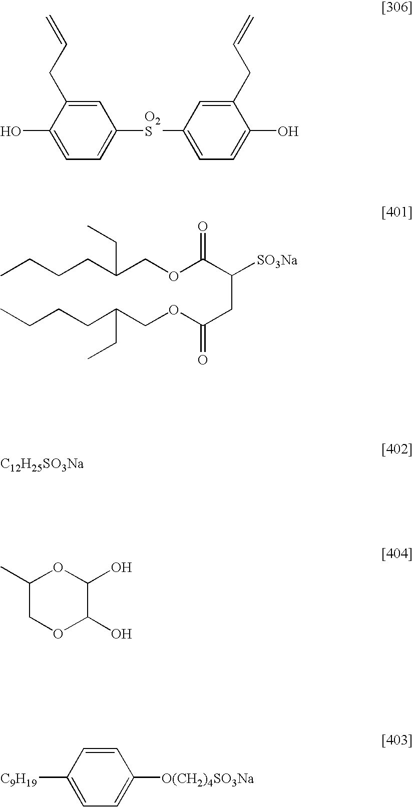
5) Preparation of Thermal Recording Layer Coating Solution A

24 g of the aforementioned electron donating dye-encapsulated micro-capsule solution A (solid matter concentration 23%), 55 g of the aforementioned electron donating dye-encapsulated micro-capsule solution B (solid matter concentration 24%), 30 g of the aforementioned color developer solid dispersion (solid matter concentration 18%), 70 g of the aforementioned color developer emulsion dispersion (solid matter concentration 22%), 1.3 g of the aforementioned 50% aqueous solution of a compound represented by the structural formula [404], 3.6 g of colloidal silica (trade name: SNOWTEX O, manufactured by Nissan Chemical Industries, Ltd.), and 6.7 g of water were mixed to prepare a thermal recording layer coating solution A.
6) Preparation of Thermal Recording Layer Coating Solution B

12.5 g of the aforementioned electron donating dye-encapsulated micro-capsule solution A (solid matter concentration 23%), 14.5 g of the aforementioned electron donating dye-encapsulated micro-capsule solution B (solid matter concentration 24%), 30 g of the aforementioned coloe developer solid dispersion (solid matter concentration 18%), 70 g of the aforementioned color developer emulsion dispersion (solid matter concentration 22%), 1.2 g of the aforementioned 50% aqueous solution of a compound represented by the structural dormula [404], 4,5 g of colloidal silica (trade name: SNOWTEX, manufactured by Nissan Chemical Industries, Ltd.) and 14.5 g of water were mixed to prepare a thermal recording layer coating solution B.

<Preparation of Intermediate Layer Coating Solution>

14500 g of water was added to 1 kg of lime-treated gelatin to dissolve it, and to this were added 137 g of a 5% solution (water/methanol=1/1 volume mixed solution) of di-2-ethylhexylsolfosuccinic acid sodium salt (trade name: NISSAN LAPIZSOLE, manufactured by Nippon Oil & Fats Co., Ltd.), 25 g of a 3.5% aqueous solution of 1,2-benzisothiazolin-3-one and 1080 g of a 3.0% aqueous solution of poly(sodium p-vinylbenzenesulfonate) [molecular weight: about 400 thousands] to prepare an intermediate layer coating solution.

<Preparation of Back Coating Later Coating Solution A>

One kg of lime-treated gelatin, 180 g of a gelatin dispersion containing 12% spherical PMMA particles having an average particle diameter of 5.7 μm, 1028 g of an emulsion having the following composition, of an ultraviolet absorption agent containing compounds represented by the following structural formulas [501] to [505] at the following contents, 0.98 g of 1,2-benzisothiazolin-3-one, 16.4 g of poly(sodium p-vinylbenzenesulfonate) [molecular weight: about 400 thousands], 3.79 g of a compound represented by the following structural formula [506], 1448 ml of a 20% latex solution of polyethyl acrylate, 52.2 g of N,N-ethylene-bis(vinylsulfonylacetamide), and 17.4 g of 1,3-bis(vinylsulfonylacetamide)propane were mixed by adding water to a total amount of 21.03 liter, to prepare a back coating layer coating solution A.

-Composition of Emulsion-

A content of an ultraviolet absorption agent per 1 kg of the aforementioned emulsion was such that a compound represented by the structural formula [501] was 14.9 g, a compound represented by the structural formula [502] was 12.7 g, a compound represented by the structural formula [503] was 14.9 g, a compound represented by the structural formula [504] was 21.1 g, and a compound represented by the structural formula [505] was 44.5 g. 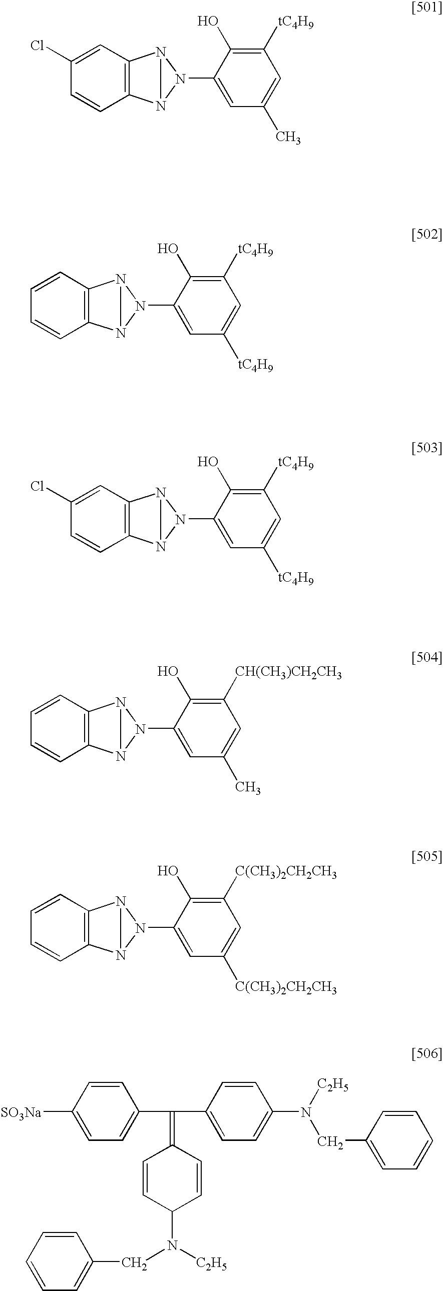
<Preparation of Back Coating Layer Coating Solution B>

One kg of lime-treated gelatin, 1015 g of a gelatin dispersion containing 15% spherical PMMA particles having an average particle diameter of 0.7 μm, 2.09 g of 1,2-benzisothiazolin-3-one, 9.53 g of sodium p-tert-octylphenoxypolyoxyethylenesulfonate, 57.9 g of polysodium acrylate [molecular weight: about 100 thousands], 22.9 g of poly(sodium p-vinylbenzenesulfonate) [molecular weight: about 400 thousands], 0.37 g of N-propyl-N-polyoxyethylene-perfluorooctanesulfonic acid amide sodium butylsulfonate, 8.97 g of hexadecyloxy-nonyl(ethyleneoxy)-ethanol, 28.1 g of 1N sodium hydroxide, 18.0 of M,M-ethylene-bis(vinylsulfonylacetamide), and 6.0 g of 1,3-(vinylsulfionylacetamide) were mixed by adding water to a total amount of 26.59 liter, to prepare a back coating layer coating solution B.

<Preparation of Thermal Recording Material>

1) Formation of Back Coating Layer

Transparent polyethylene terephthalate (PET) support [thickness 175 μm] which had been blue-colored at X=0.2850, and Y=0.2995 on a chromaticity coordinate by the method described in JIS-Z8701 was prepared, the aforementioned back coating later coating solution A and the aforementioned back coating layer coating solution B were overlaying-coated simultaneously in an order of a side nearer the PET support at respective coating amounts of 51.4 mL/m² and 14.7 mL/m² by a slide bead method.

Conditions of the aforementioned coating and drying were as follows:

That is, a coating speed was 160 m/mis., a distance between a coating die tip and a support was 0.10 to 0.30 mm, and pressure in a reduced pressure chamber was set to be lower by 200 to 900 Pa relative to the atmospheric pressure. Electricity of the PET support was removed with an ion wind before coating. In subsequently provided chilling zone, a coating solution was cooled with a wind at a dry-bulb temperature of 10 to 20° C., conveyed contactlessly, and dried with a drying wind at a dry-bulb temperature of 23 to 45° C. and a wet-bulb temperature of 15 to 21° C. using a helical-type contactless drying apparatus.
2) Preparation of Thermal Recording Layer

The above-obtained thermal recording layer coating solution A, thermal recording coating solution B, intermediate layer coating solution and protective layer coating solution were overlaying-coated simultaneously in an order of a side near a PET support, on a back coating layer-coated side of the PET support on which a back coating layer had been coating-provided and on a reverse side (on which a back coating layer had not been coating-provided), at respective coating amounts of 41.3 ml/m², 22.5 ml/m², 24.7 ml/m², and 27.5 ml/m², by a slide bead method, followed by drying, to prepare the thermal recording material (1) of the invention having a laminated structure of first thermal recording layer/intermediate layer/second thermal recording layer/protective layer on a PET support from the PET support side.

In the above procedure, a coating solution of each layer was adjusted in the temperature range of 33° C. to 37° C. In addition, the drying condition was as follows. That is, a coating speed was 160 m/min., a distance between a coating die tip and s support was 0.10 to 0.30 mm, and a pressure of a reduced chamber was set be lower by 200 to 1000 Pa relative to the atmospheric pressure. Electricity of a PET support was removed with an ion wind before coating. In addition, in an initial drying zone, a laminate was dried with a wind at a temperature of 45° C. to 55° C. and a dew point of 0 to 5° C., and dried with a drying wind at a dry-bulb temperature of 30 to 45° C. and a wet-bulb-temperature of 17 to 23° C. using a helical-type contactless drying apparatus and, after drying more 25° C., a humidity was adjusted to 40 to 60%.

### Example 2

According to the same manner as that of Example 1 except that the compound represented by the structural formula [1] was replaced with a compound represented by the following structural formula [2] (color developer in the invention) in “3) Preparation of color developer solid dispersion” in Example 1, the thermal recording material (2) of the invention was manufactured.

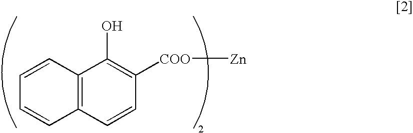

### Example 3

According to the same manner as that of Example 1 except that the compound represented by the structural formula [1] was replaced with a compound represented by the following structural formula [3] (color developer in the invention) in “3) Preparation of color developer solid dispersion” in Example 1, the thermal recording material (3) of the invention was manufactured.

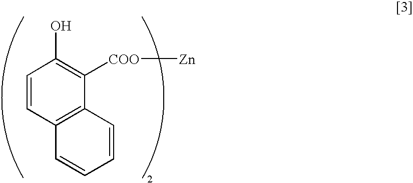

### Example 4

According to the same manner as that of Example 1 except that the compound represented by the structural formula [1] was replaced with a compound represented by the following structural formula [4] (color developer in the invention) in “3) Preparation of color developer solid dispersion” in Example 1, the thermal recording material (4) of the invention was manufactured.

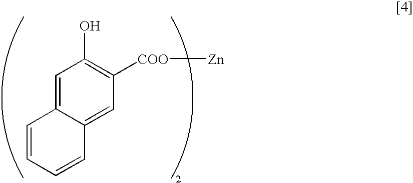

### Example 5

According to the same manner as that of Example 1 except that the compound represented by the structural formula [1] was replaced with a compound represented by the following structural formula [5] (color developer in the invention) in “3) Preparation of color developer solid dispersion” in Example 1, the thermal recording material (5) of the invention was manufactured.

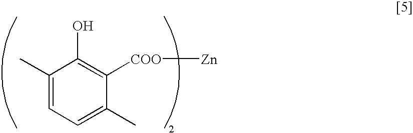

### Example 6

According to the same manner as that of Example 1 except that the compound represented by the structural formula [1] was replaced with a compound represented by the following structural formula [6] (color developer in the invention) in “3) Preparation of color developer solid dispersion” in Example 1, the thermal recording material (6) of the invention was manufactured.

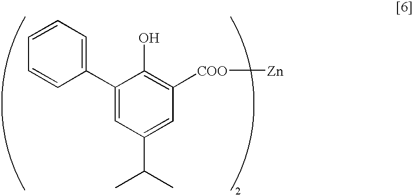

### Example 7

According to the same manner as that of Example 1 except that the compound represented by the structural formula [1] was replaced with a compound represented by the following structural formula [7] (color developer in the invention) in “3) Preparation of color developer solid dispersion” in Example 1, the thermal recording material (7) of the invention was manufactured.

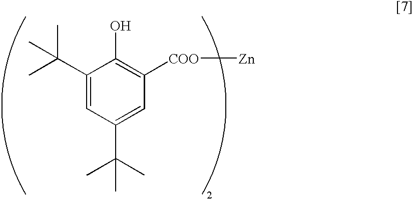

### Example 8

According to the same manner as that of Example 1 except that “4) Preparation of color developer emulsion dispersion” was replaced with the following “-Preparation of color developer emulsion dispersion α” and, at the same times, 30 g of the color developer solid dispersion was not mixed, and 70 g of the color developer emulsion dispersion was replaced with 94.5 g of the following-prepared color developer emulsion dispersion α in “5) Preparation of thermal recording layer coating solution A” and, further, 30 g of the color developer solid dispersion was not mixed, and 70 g of the color developer emulsion dispersion was replaced with 94.5 g of the following-prepared color developer emulsion dispersion α in “6) Preparation of thermal recording layer coating solution B” in Example 1, the thermal recording material (8) of the invention was manufactured.

-Preparation of Color Developer Emulsion Dispersion α-

16.5 g of a compound represented by the following structural formula [302], 6.0 g of a compound represented by the following structural formula [303], 2.0 g of a compound represented by the following structural formula [304], 2.0 g of a compound represented by the following structural formula [305], 0.4 g of a compound represented by the following structural formula [306] and 10.3 g of a compound represented by the aforementioned structural formula [5] (the aforementioned compound represented by the formula (1)) as a color developer, and 3.0 g of a compound represented by the following structural formula [301] as an ultraviolet absorption agent together with 0.8 g of tricresyl phosphate and 0.4 g of diethyl maleate were added to 16.5 g of ethyl acetate, and this was heated to 70° C. to dissolve the materials.

This mixed solution was added to an aqueous phase obtained by mixing 67 g of water, 55 g of a 8% aqueous solution of polyvinyl alcohol (trade name: PVA-217C, manufactured by Kuraray Co., Ltd.), 19 g of a 15% aqueous solution of polyvinyl alcohol (trade name: PVA-205C, manufactured by Kuraray Co., Ltd.), 11 g of a 2% aqueous solution of a compound represented by the aforementioned structural formula [402], and 11 g of a 2% aqueous solution of a compound represented by the aforementioned structural formula [403], and this was emulsion-dispersed to an average particle diameter of 0.7 μm at a rotation number of 10000 r.p.m. using an Ace homogenizer (manufactured by Nippon Seiki Co., Ltd.), to prepare a color developer emulsion dispersion α.

### Comparative Examples 1 to 3

According to the same manner as that of Example 1 except that the compound represented by the structural formula [1] was replaced with a compound represented by the following structural formula [302] (Comparative Example 1), a compound represented by the following structural formula [307] (Comparative Example 2), or a compound represented by the following structural formula [308] (Comparative Example 3) in “3) Preparation of color developer solid dispersion” in Example 1, comparative thermal recording materials (9) to (11) were manufactured.

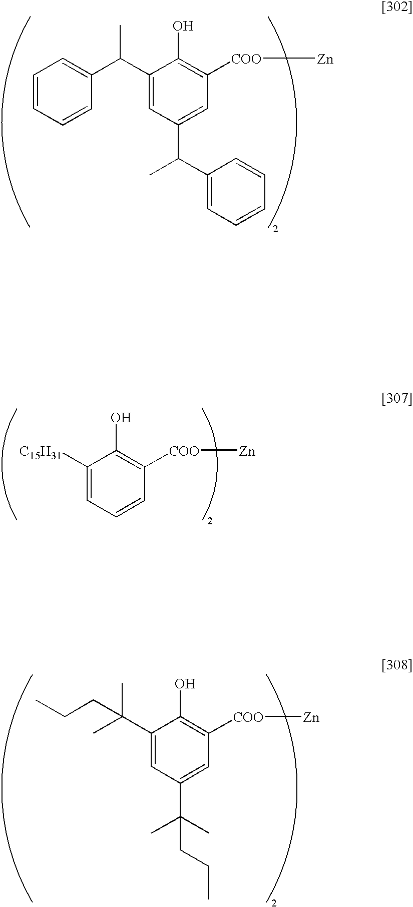

### Comparative Example 4

According to the same manner as that of Example 1 except that 30 g of the color developer solid dispersion was not mixed, and 70 g of an amount of the color developer emulsion dispersion was replaced with 94.5 g in “5) Preparation of thermal recording layer coating solution A”, and 30 g of the color developer solid dispersion was not mixed, and 70 g of an amount of the color developer emulsion dispersion was replaced with 94.5 g in “6) Preparation of thermal recording layer coating solution B”, a comparative thermal recording material (12).

Evaluation

Regarding thermal recording materials (1) to (8) of the invention obtained above, and comparative thermal recording materials (9) to (12), the following measurement and evaluation were performed. Results of measurement and evaluation are shown in the following Table 1.
1. Measurement of Haze Value and Evaluation of Transparency

The haze value of each thermal recording material was measured using a hazemeter (trade name: HGM-2DP, manufactured by Suga Test Instrument Co., Ltd.). The haze value was evaluated as follows: When the haze value is greater than 65%, this was evaluated to be a practically unacceptable range in transparency and, when the haze value is smaller than 55%, this was evaluated to be a more preferable range.
2. Measurement and Evaluation of Sensitivity

Using a thermal head (trade name: KGT 260-12MPH8, manufactured by Kyocera Corporation), heat was applied to each thermal recording material, and image recording was performed under the recording conditions at a heat pressure of 10 kg/cm², and recording energy of 70 mJ/mm². And, using a transmission densitometer (trade name: Macbeth TD904, manufactured by Macbeth), an optical density OD of each image portion was measured in a visual filter mode. The optical density OD was evaluated as follows: When the optical density is 0.5 or higher, this was evaluated to be better and, when the optical density is 0.7 or higher, this was evaluated to be more preferable.
3. Evaluation of Image Storing Property

Each of image parts, the optical density OD of which was adjusted to 0.5, was allowed to stand for one day under the environmental condition of a humidity of 30% RH and, after allowing to stand, this was taken out, the varied density width was obtained as ΔOD, and this was used as an index for evaluating storage stability of an image. When ΔOD was less than 0.10, this was evaluated to be better and, when ΔOD was less than 0.05, this was evaluated to be a more preferable range.

TABLE 1

| | | | | | OD | Image storing |
|---|---|---|---|---|---|---|
| | Material | Color developer | Dispersing manner | Haze/% | (sensitivity) | property(ΔOD) |
| Example 1 | (1) | 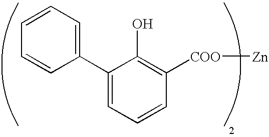 | Solid dispersing | 51 | 0.87 | 0.04 |
| Example 2 | (2) | 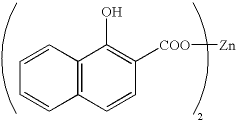 | Solid dispersing | 53 | 0.85 | 0.03 |
| Example 3 | (3) | 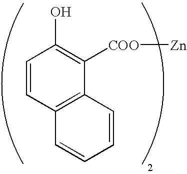 | Solid dispersing | 52 | 0.80 | 0.04 |
| Example 4 | (4) | 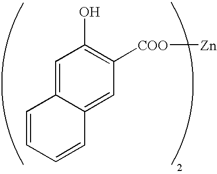 | Solid dispersing | 53 | 0.86 | 0.03 |
| Example 5 | (5) | 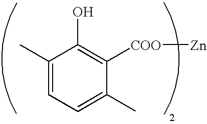 | Solid dispersing | 53 | 0.86 | 0.07 |
| Example 6 | (6) | 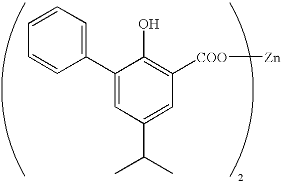 | Solid dispersing | 57 | 0.62 | 0.04 |
| Example 7 | (7) | 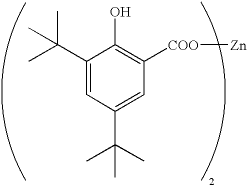 | Solid dispersing | 59 | 0.65 | 0.05 |
| Example 8 | (8) | 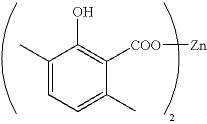 | Emulsion dispersing | 52 | 0.87 | 0.07 |
| Comparative Example 1 | (9) | 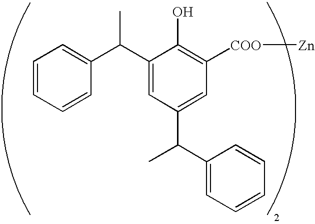 | Solid dispersing | 74 | 0.24 | 0.11 |
| Comparative Example 2 | (10) | 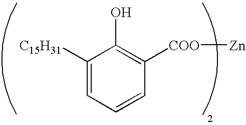 | Solid dispersing | 54 | 0.81 | 0.54 |
| Comparative Example 3 | (11) | 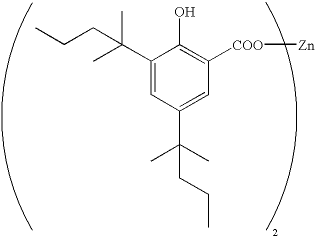 | Solid dispersing | 61 | 0.41 | 0.32 |
| Comparative Example | (12) | 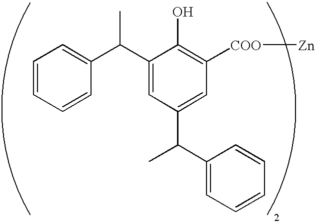 | Emulsion dispersing | 52 | 0.49 | 0.41 |

As shown in the above Table 1, in thermal recording materials (1) to (8) of the invention, the haze value was low, transparency was better and, at the same time, both of sensitivity and image storing property were excellent. By selecting the color developer in the invention (compound represented by the formula (1)) as a color developer which is reacted with an electron donating dye precursor at heating, to develop a color, it was possible to realize both of high sensitivity and image storing property and, moreover, transparence suitable for medical utility could be imparted.

To the contrary, in comparative thermal recording materials (9) to (12), not all of transparency as well as sensitivity and image storing property could be satisfied, and a thermal recording material suitable for medical utility could not be obtained.

As described above, according to the invention, a thermal recording material which is highly sensitive, excellent in storage stability of a recorded image, better in translucency (transparency), and particularly suitable in medical utility, and a method of manufacturing the same can be provided.

What is claimed is:

1. A thermal recording material comprising a thermal recording layer on a substantially transparent polymer support, the thermal recording layer containing composite particles containing a colorless or light colored electron donating dye precursor in a polymer or micro-capsules encapsulating a colorless or light colored electron donating dye precursor, and a color developer,
wherein the color developer is a compound represented by the following formula (1), and the haze value of the thermal recording material is 65% or less: 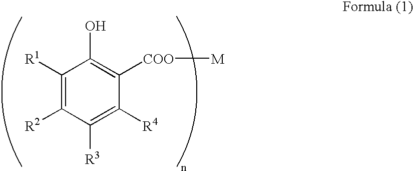
wherein R¹, R², R³, and R⁴ each independently represent a hydrogen atom, an alkyl group, an alkenyl group, an aralkyl group, or a phenyl group; the total number of carbon atoms of R¹, R², R³, and R⁴ is in the range of from 2 to 9; R¹, R², R³, and R⁴ may be bonded to each other to form a ring when at least two selected from the group consisting of R¹, R², R³, and R⁴ bind to a neighboring carbon atom; M represents an n-valent metal ion; and n represents an integer from 1 to 3.

2. The thermal recording material according to claim 1, wherein the compound represented by the formula (1) is at least one compound represented by any one of the following formulae (2) to (5) 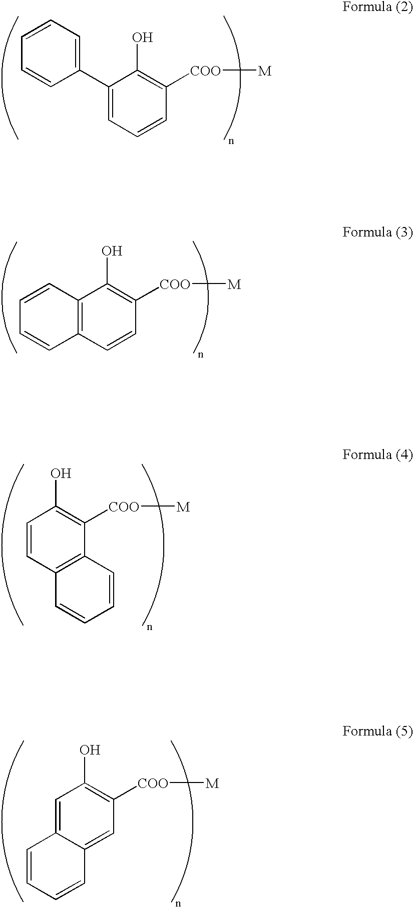
wherein M represents an n-valent metal ion, and n represents an integer from 1 to 3.

3. The thermal recording material according to claim 1, wherein M is a divalent zinc ion.

4. The thermal recording material according to claim 1, wherein the polymer support is polyethylene terephthalate having a thickness of 100 μm or more.

5. The thermal recording material according to claim 1, wherein the thermal recording layer has a thickness of 15 μm or less.

6. The thermal recording material according to claim 1, wherein the polymer support has a back coating layer containing a matting agent and a water-soluble polymer at a side on which the thermal recording layer is not provided.

7. A method of manufacturing a thermal recording material, which comprises coating on a support, a coating solution using a solid dispersion in which at least one compound represented by the following formula (1) which causes a colorless or light colored electron donating dye precursor to form color is solid-dispersed, to form a thermal recording layer: 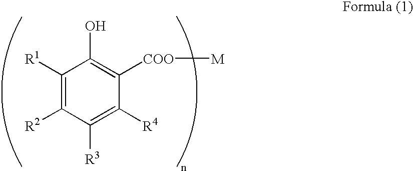
wherein R¹, R², R³, and R⁴ each independently represent a hydrogen atom, an alkyl group, an alkenyl group, an aralkyl group, or a phenyl group; the total number of carbon atoms of R¹, R², R³, and R⁴ is in the range of from 2 to 9; R¹, R², R³, and R⁴ may be bonded to each other to form a ring when at least two selected from the group consisting of R¹, R², R³, and R⁴ bind to a neighboring carbon atom; M represents an n-valent metal ion; and n represents an integer from 1 to 3.

8. The method of manufacturing a thermal recording material according to claim 7, wherein the coating solution uses a color developer dispersion obtained by mixing a solid dispersion in which at least one compound represented by formula (1) is solid-dispersed, and an emulsion dispersion in which a color developer which causes the electron donating dye precursor to form color is emulsion-dispersed.

9. The method of manufacturing a thermal recording material according to claim 7, wherein the compound represented by the formula (1) in the solid dispersion has a 50% volume average particle diameter of 0.5 μm or less.

10. The method of manufacturing a thermal recording material according to claim 7, wherein the compound represented by the formula (1) is at least one compound represented by any one of the following formulae (2) to (5) 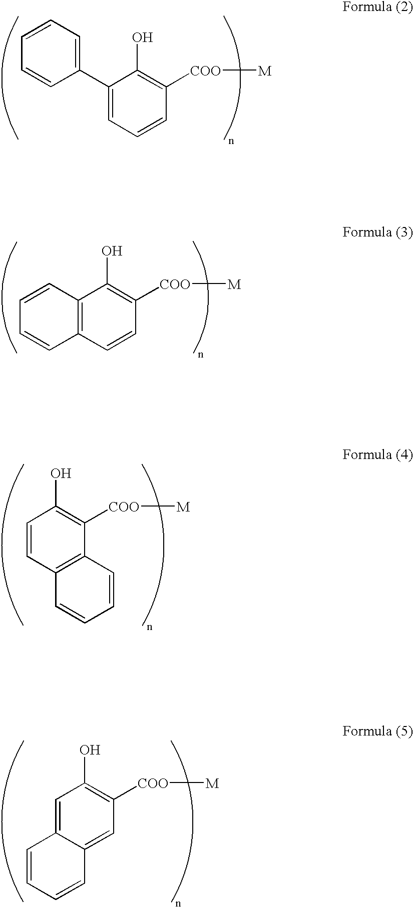
wherein M represents an n-valent metal ion, and n represents an integer from 1 to 3.

11. The method of manufacturing a thermal recording material according to claim 7, wherein M is a divalent zinc ion.

12. The method of manufacturing a thermal recording material according to claim 7, wherein the polymer support is polyethylene terephthalate having a thickness of 100 μm or more.

13. The method of manufacturing a thermal recording material according to claim 7, wherein the thermal recording layer has a thickness of 15 μm or less.

14. The method of manufacturing a thermal recording material according to claim 7, wherein the polymer support has a back coating layer containing a matting agent and a water-soluble polymer at a side on which the thermal recording layer is not provided.
